(19) United States
(12) Patent Application Publication
(10) Pub. No.: US 2014/0136910 A1
(43) Pub. Date: May 15, 2014

(54) DATA COMMUNICATION APPARATUS AND CONTROL METHOD

(71) Applicant: FUJITSU LIMITED, Kawasaki-shi (JP)

(72) Inventor: Yoshitsugu GOTO, Kawasaki (JP)

(73) Assignee: FUJITSU LIMITED, Kawasaki-shi (JP)

(21) Appl. No.: 14/157,620

(22) Filed: Jan. 17, 2014

Related U.S. Application Data
(63) Continuation of application No. PCT/JP2011/067710, filed on Aug. 2, 2011.

(51) Int. Cl. G06F 11/16

(52) U.S. Cl. CPC G06F 11/1666
USPC 714/718

(57) ABSTRACT

A data communication apparatus includes a data generation unit, a control register, a memory, a memory address generation unit, a failure setting unit, and a transmission unit. The data generation unit generates data. The control register outputs an enable signal and a test control signal. In the memory, pseudo failure data is written during the test. The pseudo failure data is used to modify generated data to data having a pseudo failure. The memory address generation unit generates a readout address of the memory during the test on the basis of the enable signal and the test control signal. The failure setting unit reads out pseudo failure data from the memory using a readout address generated by the memory address generation unit, and modifies the generated data to data having the pseudo failure. The transmission unit transmits the data having the pseudo failure modified by the failure setting unit.

### CROSS-REFERENCE TO RELATED APPLICATION(S)

This application is a continuation of International Application No. PCT/JP2011/067710, filed on Aug. 2, 2011, the entire contents of which are incorporated herein by reference.

### FIELD

The embodiments discussed herein are related to a data communication apparatus and a control method.

### BACKGROUND

Conventionally known is a technique for verifying the Reliability, Availability, and Serviceability (RAS) of an information system apparatus. Known as an example of such a technique is a memory controller for evaluating the RAS of a memory by transmitting, to the memory, data having pseudo error produced by inverting a bit of a data signal.

Known as an example of such a memory controller is one which stores, in a register, an error bit indicative of the pattern of a pseudo error to be produced and provides data to be transmitted to the memory with the pseudo error produced depending on the pattern of the error bit stored in the register. For example, such a memory controller has a plurality of registers corresponding to the position of each bit of the data to be transmitted to the memory and stores, in each register, a bit for producing a pseudo error.

Then, the memory controller computes the exclusive OR of the bit stored in each register and the data to be transmitted to the memory, whereby each bit of the data to be transmitted to the memory is inverted depending on the pattern of the bit stored in the register so as to produce data having the pseudo error. Subsequently, the memory controller transmits the data having the pseudo error to the memory and evaluates the RAS of the memory depending on the error detection result in the memory.

Also known is a technique which provides a register storing a plurality of bit patterns and inverts a it of data to be transmitted to a memory depending on the pattern of each bit stored in the register. To verify the RAS of the memory, the memory controller to which such a technique is applied sequentially computes the exclusive OR of the data to be transmitted to the memory and each bit pattern stored in the register, and then transmits the resulting exclusive OR to the memory. With regard to conventional technologies, see Japanese Laid-open Patent Publication No. 2007-200300 and Japanese Laid-open Patent Publication No. 54-36147, for example.

However, the aforementioned techniques for storing an error bit in a register have the problem in that the RAS is not continually verified for multiple patterns of pseudo error.

Now, referring to the drawings, a description will be made to an example of a technique for storing an error bit in a register by JTAG (Joint Test Action Group. FIG. 18 is an explanatory view illustrating a conventional example of a technique for verifying the RAS. in the example illustrated in FIG. 18, a memory controller 100 has a JTAG 101 and an internal logic 110 and is connected to a service processor 102 and a memory 103. The internal logic 110 has an error generation circuit 111, an address counter 115, and a history memory 116.

Furthermore, the error generation circuit 111 has a data communication control circuit 112, an error generate (EG) control bit 113, and an exclusive OR (EOR) gate 114. Furthermore, the memory 103 has an error check and correct (ECC) determination unit 104.

For example, upon reception of an access command, the data communication control circuit 112 transmits, to the memory 103, 32-bit DATA[0:31], and 7-bit check bit (CB) [0:6] to be used for ECC. In such a case, the memory 103 uses the ECC determination unit 104 to compare the CB[0:6] produced from the received DATA[0:31] with the received CB[0:6], thereby determining whether an error has occurred in the DATA[0:31].

Furthermore, the memory controller 100 uses a “LOAD_EG_CNTL” signal or a JTAG command to store, in the EG control bit 113, JDR (JTAG data register) [0:31] as data for producing a pseudo failure. Then, the memory controller 100 computes the exclusive OR of the hit stored in the EG control bit 113 and the DATA[0:31], thereby producing data having a pseudo. error.

That is, the memory controller 100 inverts a hit of the DATA[0:31] depending on the pattern of the bit stored in the EG control bit 113, thereby producing the data having the pseudo error. Subsequently, the memory controller 100 transmits the data having the pseudo error to the memory 103 and evaluates the RAS of the memory 103 depending on the result of detecting an error by the ECC determination unit 104.

Furthermore, the memory controller 100 stores the DATA[0:31] as Write Data WD[0:31] in an address generated by the address. counter 115 in the history memory 116. Then, upon reception of a history readout request, the memory controller 100 outputs, as Read Data RD[0:31], the WD[0:31] stored in the history memory 116 through the JTAG 101, thereby facilitating the analysis of the cause of a failure.

Now, referring to a drawing, a description will be made to an example of the error generation circuit 111 that the memory controller 100 has. FIG. 19 is an explanatory view illustrating an example of a conventional error generation circuit. In the example illustrated in FIG. 19, the data communication. control circuit 112 has a data transmission circuit 112a and a Check Fit Generate (CG) 112b. On the other hand, the error generation circuit 111 has four EOR gates 114.

In the example illustrated in FIG. 19, upon reception of an access command, the data transmission Circuit 112a generates the DATA[0:31] and outputs the generated DATA[0:31]. The CG 112b generates the C[0:6] from the DATA[0:31] received from the data transmission circuit 112a and then transmits the generated CB[0:6] to the memory 103.

Furthermore, each of the FOR gates 114 receives the 1st bit DATA[0], the ninth bit DATA[8], the 17th bit DATA[16], and the 25th bit DATA[24] of the DATA[0:31]. Each of the EOR gates 114 computes the exclusive OR of the bit stored in the EG control bit 113 and the received data. That is, each of the FOR gates 114 inverts the bit at a predetermined position of the 32-bit DATA[0:31] on the basis of the pattern of the bits stored in the EG control bit 113. Then, each of the FOR gates 114 outputs the computed exclusive OR as the DATA[0], DATA[8], DATA[16], and DATA[24].

Now, referring to FIG. 20, a description will be made to the flow of the process executed by the memory controller 100. FIG. 20 is an explanatory view illustrating an example of the flow of a process executed by a conventional memory controller. In the example illustrated. in FIG. 20, the memory controller 100 sets the EG control bit 113 via the JTAG 101 (step S1).

Then, when executing the access command (step S2), the memory controller 100 inverts the bit at a predetermined position of the DATA[0:31] on the basis of the bit pattern stored in the EG control bit 113 (step S3). Subsequently, the memory controller 100 transmits the DATA[0:31] with the hit at the predetermined position inverted to the memory 103 and allows the memory 103 to detect an SOC error (step S4).

Such a memory controller 100 produces a pseudo error using the bit stored in the EG control bit 113. Thus, to the mechanism for maintaining the RAS of the memory in for multiple patterns of pseudo error, the memory controller 100 has to store again a bit indicative of another pattern in the EG control bit 113 each time a pseudo error is produced. As a result, for multiple patterns of pseudo error, it is not possible to continually verify the RAS.

Furthermore, the technique to provide registers that store bits indicative of multiple patterns of pseudo error requires registers for storing pseudo error patterns for the width of all the bits of data, thus leading to an increase in circuit scale. On the other hand, when the number of registers is reduced to prevent such an increase in circuit scale, the positions of the bits that can be inverted are reduced. As a result, it is not possible to verify the RAS for the width of all the bits of data. This leads to a problem in that the RAS will be verified insufficiently.

### SUMMARY

According to an aspect of an embodiment, a data communication apparatus includes a data generation unit, a control register, a memory, a memory address generation unit, a failure setting unit, and a transmission unit. The data generation unit generates data to be transmitted. to another apparatus. The control register outputs an enable signal indicative of whether to enable a test of the another apparatus and a test control signal to be used to control the test. The memory is used for a predetermined use during other than the test and in which pseudo failure data is written during the test, the pseudo failure data being used to modify data generated by the data generation unit to data having a pseudo failure. The memory address generation unit generates a readout address of the memory during the test on the basis of the enable, signal and the test control signal. The failure setting unit, when the enable signal indicates that the test has been enabled, reads out pseudo failure data from the memory using a readout address generated by the memory address generation unit, and on the basis of the read pseudo failure data, modifies the data generated by the data generation unit to data having the pseudo failure. The transmission unit transmits the data having the pseudo failure modified by the failure setting unit to the another apparatus.

According to another aspect of an embodiment, a method for controlling a data communication apparatus which transmits data to another apparatus, causes the data communication apparatus to execute: firstly generating data to be transmitted to the another apparatus; outputting an enable signal indicative of whether to enable a test of the another apparatus and a test control signal to be used to control the test; secondly generating a readout address of a memory during the test on the basis of the enable signal and the test control signal; reading pseudo failure data from the memory using the generated readout address when the enable signal indicates that the test has been enabled; modifying the data generated in the firstly generating to data having a pseudo failure on the basis of the read pseudo failure data; and transmitting the data having the pseudo failure to the another apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating a memory controller according to a first embodiment;

FIG. 2 is an explanatory view illustrating an example of an EG control register according to the first embodiment;

FIG. 3 is an explanatory view illustrating an example of data stored in the EG control register according to the first embodiment;

FIG. 4 is an explanatory view illustrating an example of an address counter according to the first embodiment;

FIG. 5 is an explanatory view illustrating a circuit example of a history memory address designating unit according to the first embodiment;

FIG. 6 is an explanatory view illustrating a circuit example of the EG control. address designating unit according to the first embodiment;

FIG. 7 is an explanatory flowchart illustrating an example of the flow of a process executed by the memory controller according to the first embodiment;

FIG. 8 is an explanatory flowchart illustrating an example of a process for the memory controller according to the first embodiment to continually insert multiple patterns of pseudo error;

FIG. 9 is an explanatory view illustrating a MAC according to a second embodiment;

FIG. 10 is an explanatory view illustrating an example of an EG control register according to the second embodiment;

FIG. 11 is an explanatory view illustrating an example of data stored in the EG control register according to the second embodiment;

FIG. 12 is an explanatory view illustrating an example of an address counter according to the second embodiment;

FIG. 13 is an explanatory view illustrating an example of a failure information register according to the second embodiment;

FIG. 14 is an explanatory view illustrating an example of information stored in the failure information register according to the second embodiment;

FIG. 15 is an explanatory view illustrating an example of a circuit in which bits are inverted by the MAC according to the second embodiment;

FIG. 16 is an explanatory first flowchart illustrating the flow of a process executed by the MAC according to the second embodiment;

FIG. 17 is an explanatory second flowchart illustrating the flow of a process executed by the MAC according to the second embodiment;

FIG. 18. is an explanatory view illustrating an example of a conventional technique for verifying the RAS;

FIG. 19 is an explanatory view illustrating an example of a conventional error generation circuit; and

FIG. 20 is an explanatory view illustrating an example of the flow of a process executed by a conventional memory controller.

### DESCRIPTION OF EMBODIMENTS

Preferred embodiments of the present invention will be explained with reference to accompanying drawings.

### [a] First Embodiment

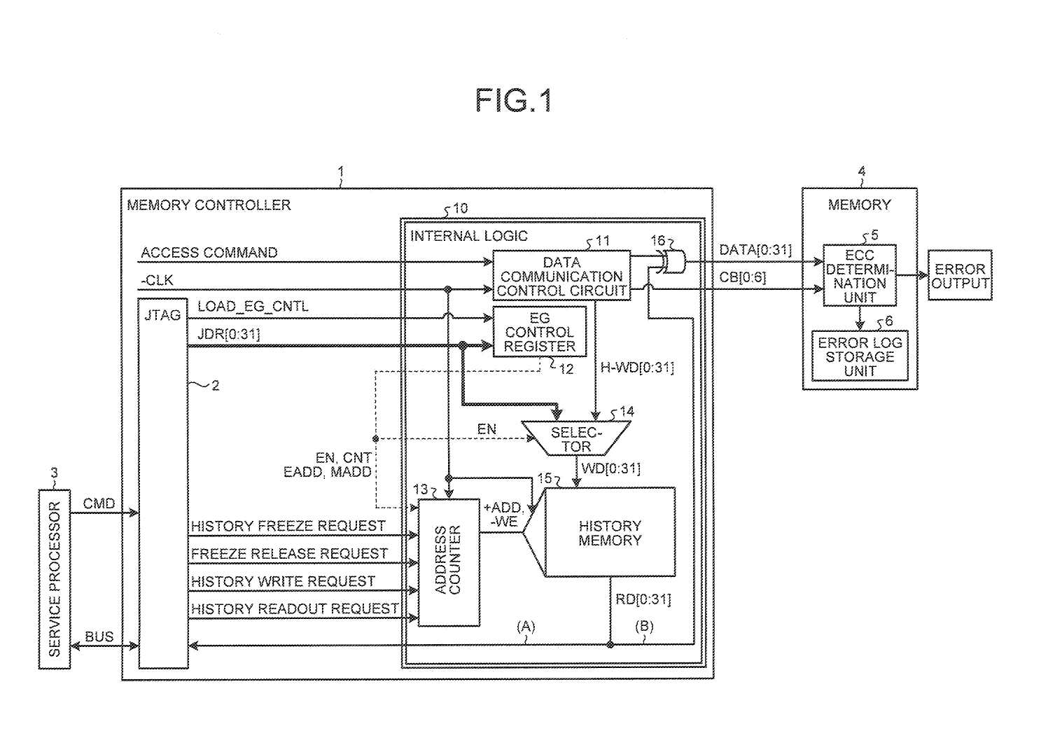

In a first embodiment below, referring to FIG. 1, a description will be made to an example of a memory controller. FIG. 1 is an explanatory view illustrating a memory controller according to the first embodiment.

As illustrated in FIG. 1, a memory controller 1 is connected to a service processor 3 and a memory 4. Furthermore, the memory controller 1 has a Joint Test Action Group (JTAG) 2 and an internal logic 10. Furthermore, the internal logic 10 has a data communication control circuit 11, an EG control register 12, an address counter 13, a selector 14, a history memory 15, and an Exclusive OR (EOR) gate 16. Furthermore, the memory 4 has an Error Check and Correct (ECC) determination unit 5 and an error log storage unit 6.

The JTAG 2 is connected to the service processor 3 through a BUS so as to receive a CMD signal indicative of a JTAG command from the service processor 3 via the BUS. Then, the JTAG 2 controls the internal logic 10 on the basis of the JTAG command indicated by the received CMD signal.

For instance, in the example illustrated in FIG. 1, using the LOAD_EG_CNTL signal, the JTAG 2 allows the EG control register 12 to store, in the EG control register 12, 32-bit data JDR[0:31] set by a JTAG Data Register (JDR). Furthermore, the JTAG 2 transmits the JDR[0:31] to the selector 14 included in the internal logic 10.

Furthermore, the JTAG 2 transmits a history freeze request, a freeze release request, a history write request, and a history readout request to the address counter 13 included in the internal logic 10. The history freeze request is herein a request for stopping the process of storing, in the history memory 15, History Write Data H-WD[0:31] which is 32-bit data generated by the data communication control circuit 11 as data to be transmitted to the memory 4.

Furthermore, the freeze release request is a request for restarting the process of storing the H-WD[0:31] in the history memory 15. Furthermore, the history write request is a request for executing the process of storing an error bit in the history memory 15. Furthermore, the history readout request is a request for reading the H-WD[0:31] stored in the history memory 15, that is, a request for reading history data.

Note that when the history readout request is transmitted to the address counter 13, the JTAG 2 acquires, as Read Data RD[0:31], the H-WD[0:31] stored in the history memory 15 by way of the path (A) illustrated in FIG. 1.

The service processor 3 transmits the BUS and the CMD, which are interface signals, to the JTAG 2 in order to allow the JTAG 2 to issue each request.

Now a description will be made to the data communication control circuit 11, the EG control register 12, the address counter 13, the selector 14, the history memory 15, and the FOR gate 16 which are included in the internal logic 10. First, in response to a command for access to the memory 4, the data communication control circuit 11 produces the 32-bit DATA[0:31] to be transmitted to the memory 4. Then, the data communication control circuit 11 transmits the generated DATA[0:31] to the EOR gate 16. Furthermore, the data communication control circuit 11 transmits the generated DATA[0:31] as the H-WD[0:31] to the selector 14.

Furthermore, the data communication control circuit 11 produces a Check Bit CB[0:6] for detecting an error occurring from the generated DATA[0:31] during transmission. Then, the data communication control circuit 11 transmits the generated CB[0:6] to the memory 4.

The EG control register 12 outputs an enable signal indicative of whether to enable the test for verifying the ECC of the memory 4 and a test control signal to be used to control the test. More specifically, the EG control register 12 is a register for storing 32-bit data and stores the JDR[0:31] to be set by the LOAD_EG_CNTL signal received from the JTAG 2. Then, the EG control register 12 outputs the stored 32-bit data to the address counter 13 and the selector 14.

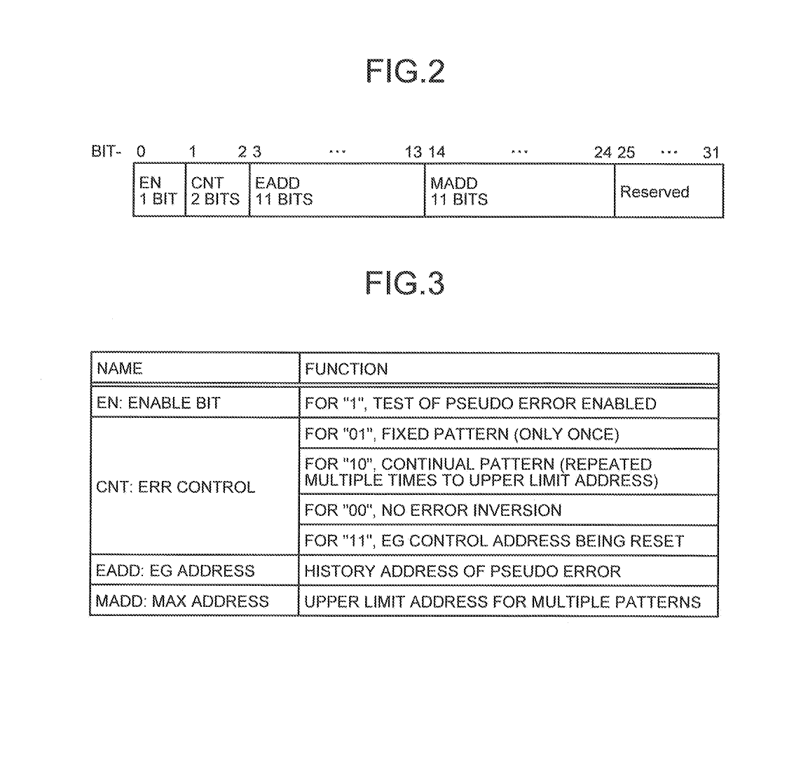

Now, referring to a drawing, a description will be made to an example of the EG control register 12. First, referring to FIG. 2, a description will be made to the contents of the data stored in the EG control register 12. FIG. 2 is an explanatory view illustrating an example of the EG control register according to the first embodiment. In the example illustrated in FIG. 2, the EG control register 12 has a 32-bit storage region from the 0th bit to the 31st bit, allowing the JDR[0:31] to be stored in each storage region.

More specifically, the EG control register 12 stores the 0th bit data of the JDR[0:31] as one-bit EN[0] (ENABLE BIT). The EG control register 12 also stores data from the 1st to 2nd bits of the JDR[0:31] as 2-bit CNT (ERR CONTROL)[0:1]. The EG control register 12 further stores data from the 3rd to 13th bits of the JDR[0:31] as 11-bit EADD (EG ADDRESS)[0:10].

The EG control register 12 also stores data from the 14th to 24th hits of the JDR[0:31] as 11-bit MADD (MAX ADDRESS) [0:10]. Note that the EG control register 12 stores the 25th to 31st bits of the JDR[0:31] as a reserved region (Reserved). Then, the EG control register 12 transmits the EN[0], the CNT[0:1], the EADD[0:10], and the MADD[0:10], which have been stored, to the address counter 13 and outputs the EN[0] to the selector 14.

Now, referring to FIG. 3, a description will be made to each data stored in the EG control register 12. FIG. 3 is an explanatory view illustrating an example of data stored in the EG control register according to the first embodiment. The EN[0] stored in the EG control register 12 is the information indicative of whether to execute the test of evaluating the RAS of the memory 4 using a pseudo error. In the example illustrated in FIG. 3, the memory controller 1 executes the test of evaluating the RAS of the memory 4 when the EN[0] is “1” (i.e., “High”). On the other hand, the memory controller 1 does not execute the test of evaluating the RAS of the memory 4 when the EN[0] is “0” (i.e., “Low”).

Now, prior to the explanation of the CNT[0:1], a description will be made to the EADD[0:10] and the MADD[0:10]. The EADD[0:10] is a history address indicative of a storage region, among the storage regions of the history memory 15, for storing an error bit. More specifically, the EADD[0:10] is a history address indicative of a storage region, among the storage regions in which the history memory 15 stores a plurality of patterns of pseudo error, for storing an error bit that the memory controller 1 inserts in the first place.

The MADD is a history address indicative of a storage region for storing the pattern of pseudo error that the memory controller 1 inserts in the last place, among the plurality of patterns of pseudo error stored in the history memory 15. That is, the memory controller 1 executes the following processing when continually inserting different patterns of pseudo error into the DATA[0:31]. That is, the memory controller 1 inserts, into the DATA[0:31], the error bits that are stored in the storage: regions indicated by the history addresses from the EADD[0:10] to the MADD.

The CNT[0:1] is information to be used for controlling a test. More specifically, the CNT[0:1] is indicative of the type of pseudo error to be inserted into data by the memory controller 1. In the example illustrated in FIG. 3, when the CNT[0:1] is “01,” the memory controller 1 inserts only once one pattern of error bits into the DATA[0:31] to be transmitted to the memory 4.

On the other hand, when the CNT[0:1] is “10,” the memory controller 1 continually inserts, into the DATA[0:31], the error bits stored in the storage regions indicated by the history addresses from the EADD[0:10] to the MADD[0:10]. That is the memory controller 1 continually transmits, to the memory 4, multiple pieces of DATA[0:31] into which different error hits have been each inserted.

Furthermore, when the CNT[0:1] is “00,” the memory controller 1 does not insert an error bit. Furthermore, when the CNT[0:1] is “11,” the memory controller 1 resets an EG control address designated by the address counter 13. Here, the EG control address is a history address indicative of a storage region in which an error bit is stored.

Referring back to FIG. 1, the address counter 13 produces the readout address of the history memory 15 on the basis of the EN[0] and the CNT[0:1] which are outputted by the EG control register 12. More specifically, upon reception of the history freeze request from the JTAG 2, the address counter 13 is brought into a state for readout of history memory. Then, each time the history readout request is received, the address counter 13 produces a history address for reading the RD[0:31] from the history memory 15.

Furthermore, the address counter 13 holds a history memory address having been just generated, and to create a new history memory address, produces, as a new history memory address, a value obtained by incrementing the held history memory address by one.

Furthermore, upon reception of the freeze release request, the address counter 13 stops generating the history memory address for reading the RD[0:31] and restarts writing history data, that is, the WD[0:31] on the history memory 15. Furthermore, upon reception of the history write, request, the address counter 13 generates the EG control address for storing an error bit.

Now, a description will be made to a specific example in which the address counter 13 generates the EG control address and outputs the generated EG control address. For example, the address counter 13 receives the EN[0], the CNT[0:1], the EADD[0:10], and the MADD[0:10], which are outputted by the EG control register 12. Then, the address counter 13 generates the EG control address according to the received CNT[0:1].

Furthermore, when the EN[0] is indicative of the execution of the test, the address counter 13 outputs the generated EG control address. Then, the address counter 13 holds the EG control address having been just generated, and to create a new EG control address, produces, as a new EG control address, a value obtained by incrementing the held EG control address by one.

More specifically, when the CNT[0:1] is [01], the address counter 13 produces only one history address of the storage region in which an error bit is stored. Furthermore, when the CNT[0:1] is [10], the address counter 13 sequentially produces the history addresses from the EADD[0:10] to the MADD[0:10].

Then, when the received EN[0] is “High,” the address counter 13 outputs the generated EG control address to the history memory 15. Note that when the CNT[0:1] is [00], the address counter 13 does not generate a history address. Furthermore, when the CNT[0:1] is [11], the address counter 13 resets the EG control address.

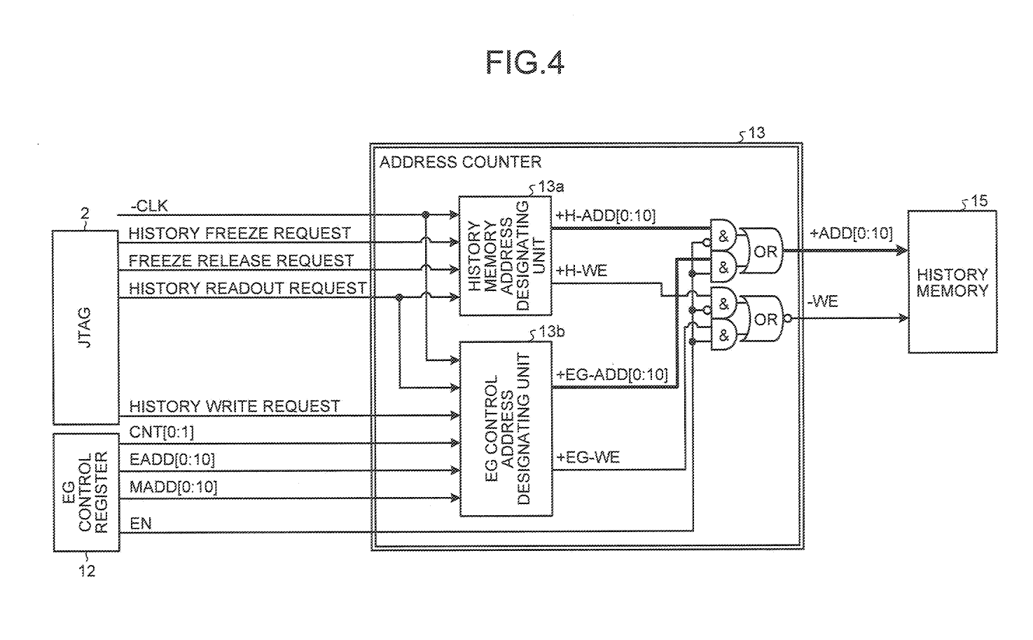

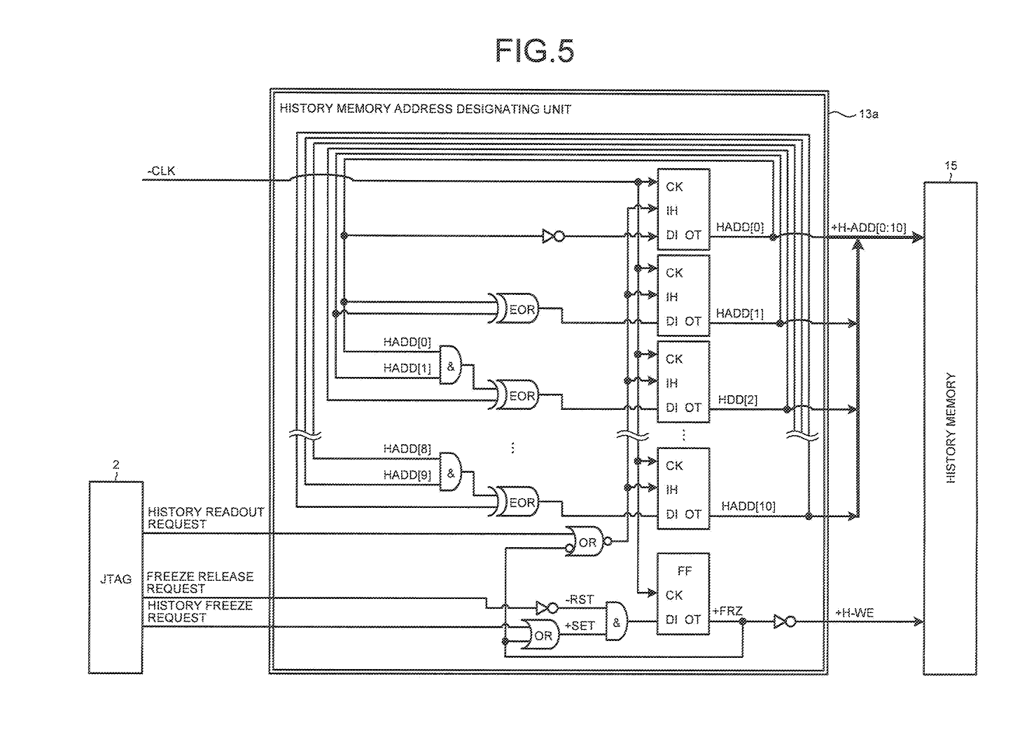

Now, referring to FIG. 4, a description will be made to an example of the address counter 13. FIG. 4 is an explanatory view illustrating an example of the address counter according to the first embodiment. In the example illustrated in FIG. 4, the address counter 13 has a history memory address designating unit 13a and an EG control address designating unit 13b.

Furthermore, in the example illustrated in FIG. 4, the address counter 13 inputs a −CLK, signal or a system clock, the history freeze request, the freeze release request, and the history readout request to the history memory address designating unit 13a. The address counter 13 also inputs the −CLK signal, the history readout request, the history write request, the CNT[0:1], the EADD[0:10], and the MADD[0:10] to the EG control address designating unit 13b.

The history memory address designating unit 13a receives the history freeze request, the freeze release request, and the history readout request. Then, on the basis of each received request, the history memory address designating unit 13a outputs a +H-ADD[0:10] indicative of a history address to be read and a +H-WE to command to write on the history memory 15.

For example, to command to write a history, the history memory address designating unit 13a outputs “High” as the +H-WE and outputs the +H-ADD[0:10] to the history memory 15. In such a case, the history memory 15 stores the history in a storage region indicated by the +H-ADD[0:10].

Furthermore, to command to read out from the history memory 15, the history memory address designating unit 13a outputs “Low” as the +H-WE and outputs the +H-ADD[0:10] to the history memory 15. In such a case, the history memory 15 outputs to the JTAG 2 a history stored in the storage region indicated by the +H-ADD[0:10].

The EG control address designating unit 13b receives the −CLK signal, the history readout request, the history write request, the CNT[0:1], the EADD[0:10], and the MADD[0:10]. Then, in response to each request, the CNT[0:1], the EADD[0:10], and the MADD[0:10] which have been received, the EG control address designating unit 13b outputs a +EG-ADD[0:10] or an EG control address and a +EG-WE for commanding to write.

For example, to command to write the EG control address on the history memory 15, the EG control address designating unit 13b outputs “High” as the +EG-WE and outputs the +EG-ADD[0:10] thereto. In such a case, the history memory 15 stores an error bit in the storage region indicated by the +EG-ADD[0:10].

Furthermore, to command to read the EG control address out from the history memory 15, the EG control address designating unit 13b outputs “Low” as the +EG-WE and outputs the +EG-ADD[0:10]. In such a case, the history memory 15 outputs the error bit stored in the storage region indicated by the +EG-ADD[0:10].

The address counter 13 has herein an AND gate for computing the logical product of the +H-ADD[0:10] and the inverted received EN[0] and an AND gate for computing the logical product of the +EG-ADD[0:10] and the EN[0]. Then, the address counter 13 computes the logical OR of each of the AND gates, thereby outputting the +H-ADD[0:10] or the +EG-ADD[0:10] as a +ADD[0:10].

That is, when the EN[0] is “Low,” the address counter 13 outputs the +H-ADD[0:10] as the +ADD[0:10] to the history memory 15. Furthermore, when the EN[0] is “High,” the address counter 13 outputs the +EG-ADD[0:10] as the +ADD[0:10] to the history memory 15.

The address counter 13 also has an AND gate for computing the logical product of the +H-WE and the inverted received EN[0] and an AND gate for computing the logical product of the +EG-WE and the EN[0]. Then, the address counter 13 computes the logical OR of each of the AND gates and outputs the inverted signal of the computed logical OR as a −WE.

That is, when the EN[0] is “Low,” the address counter 13 outputs the inverted signal of the +H-WE as the −WE to the history memory 15. On the other hand, when the EN[0] is “High,” the address counter 13 outputs the inverted signal of the +EG-WE as the −WE to the history memory 15.

Now, referring to FIG. 5, a description will be made to a circuit example of the history memory address designating unit 13a. FIG. 5 is an explanatory view illustrating the circuit example of the history memory address designating unit according to the first embodiment. In the example illustrated in FIG. 5, the history memory address designating unit 13a includes an 11-bit up-counter with eleven D-FFs (Flip Flops) connected, each having a clock (CK) terminal and an inhibit (IH) terminal.

Each FF of such an up-counter holds each bit of the +H-ADD[0:10] or HADD[0] to HADD[10]. Then, each FF outputs the HADD[0] to HADD[10] being held as the +H-ADD[0:10]. Furthermore, when “Low” is supplied to the IH terminal, each FF executes the following processing.

That is, the FF holding the HADD[0] is supplied, in every clock cycle of the −CLK signal, with the held value being inverted. Furthermore, the FF holding the HADD[1] holds, in every clock cycle of the −CLK signal, a new exclusive OR of the HADD[1] outputted by that FF and the HADD[0].

Furthermore, each of the FPS holding the ADD[2] to the HADD[10] holds, in every clock cycle, of the −CLK signal, a new exclusive OR of the logical product of two lower-order bits than the HADD held by that FF and the HADD outputted by that FF. That is, when “Low” is supplied to the IH terminal, each FF operates as an up-counter for counting up the values of the HADD[0] to HADD[10] in every clock cycle of the vCLK signal.

Furthermore, the history memory address designating unit 13a has a one bit set/reset circuit which outputs a +FRZ to thereby control a clock inhibit (IH) to be supplied to each FF of the up-counter. More specifically, the history memory address designating unit 13a computes the logical OR of the inverted signal of the output from the register of the set/reset circuit and the history readout request, and supplies the inverted signal of the computed logical OR as an IN to each FF of the up-counter. Furthermore, the history memory address designating unit 13a supplies the −CLK signal to the CK of each FF.

Now, a description will be made to the operation of the history memory address designating unit 13a. For example, since the +FRZ outputted from the FF of the set/reset circuit becomes “Low” when a. history is written on the history memory 15, the history memory address designating unit 13a supplies the IN “Low” to each FF of the up-counter. Thus, the up-counter of the history memory address designating unit 13a counts up the +H-ADD[0:10] while outputting the +H-ADD[0:10]. Furthermore, the history memory address designating unit 13a outputs, as the +H-WE, “High” obtained by inverting the +FRZ.

As a result, while outputting “High” as the +H-WE, the history memory address designating unit 13a outputs the +H-ADD[01:0] being changed in increments of one in every clock cycle of the −CLK signal. Thus, the history memory address designating unit 13a can store histories on the storage regions indicated by consecutive history addresses of the history memory 15.

Furthermore, the history memory address designating unit 13a is configured such that when the history freeze request is received from the JTAG 2 upon occurrence of a system error, a +SET of the set/reset circuit becomes “High” and a −RST becomes “High.” As a result, the +FRZ outputted from the FF of the set/reset circuit becomes “High” and the IN supplied to each FF of the up-counter becomes “High,” resulting in the history memory address designating unit 13a stopping the count-up of the +H-ADD[0:10].

Furthermore, the history memory address designating unit 3a outputs “Low” as the +H-WE. Thus, the history memory 15 is in a history readout state. Subsequently, each time the history readout request is received from the JTAG 2, the history memory address designating unit. 13a outputs, to the history memory 15, the +H-ADD[0:10] being changed in increments of one. Thus, the history memory address designating unit 13a can output the histories stored in the storage regions indicated by consecutive history addresses.

Furthermore, when the freeze release request is received from the JTAG 2, the −RST becomes “Low,” thus causing the output +FRZ from the FF of the set/reset circuit to be reset to “Low.” As a result, the history memory address designating unit 13a can restart to write a history on the history memory 15.

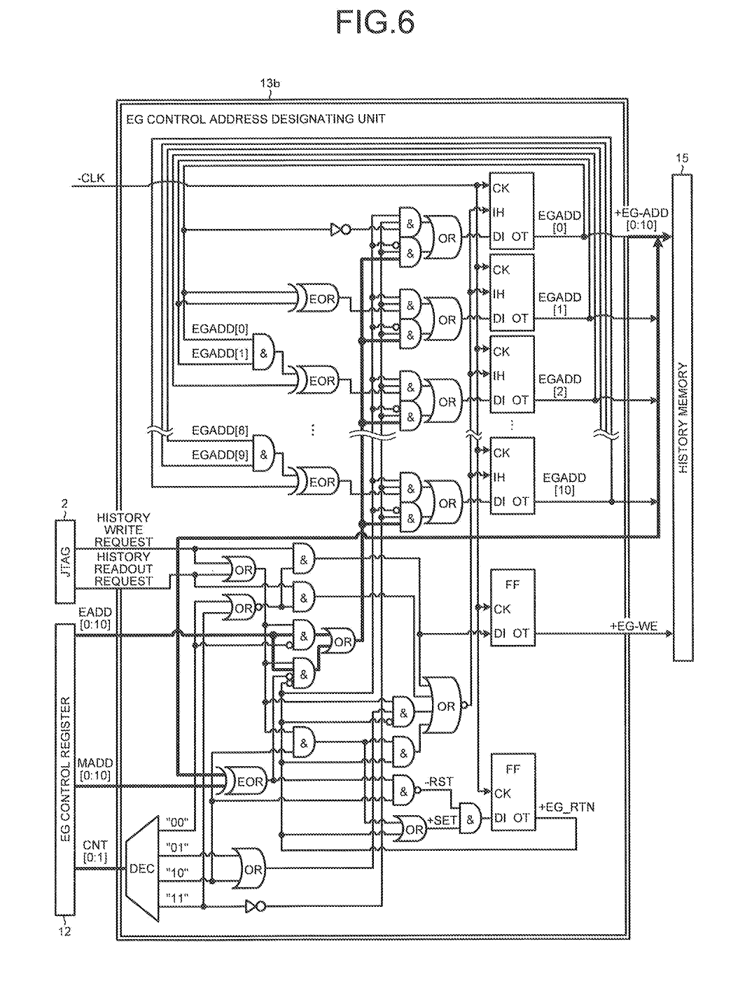

Now, referring to FIG. 6, a description will be made to a circuit example of the EG control address designating unit 13b. FIG. 6 is an explanatory view illustrating the circuit example of the EG control address designating unit according to the first embodiment. In the example illustrated in FIG. 6, like the history memory address designating unit 13a, the EG control address designating unit 13b includes an 11-bit up-counter with eleven D-FFs connected, each having a CK terminal and an IN terminal. Each FF of such an up-counter holds EGADD[0] to EGADD[10] which are each bit of the +EG-ADD[0:10]. Furthermore, the EG control address designating unit 13b supplies the −CLK signal to the CK terminal of each FF of the up-counter.

Furthermore, the EG control address designating unit 13b has a one-bit FF and a one-bit set/reset circuit for controlling, by a +EG RTN, the IN supplied to each FF of the up-counter. Now, a description will be made to the operation of such an EG control address designating unit 13b. Note that of the operations to be executed by the EG control address designating unit 13b, the operations similar to those executed by the history memory address designating unit 13a will be omitted as appropriate.

First, a description will be made to the operation to be performed by the EG control address designating unit 13b to write an error bit on the history memory 15. For example, the EG control address designating unit 13b receives the history write request from the JTAG 2 when the CNT[0:1] received from the EG control register 12 is “01” or “10.” In such a case, the EG control address designating unit 13b supplies the IM “Low” to each FF of the up-counter. Furthermore, the EG control address designating unit 13b allows each FE of the up-counter to hold the EADD[0:10], which has been received from the EG control register 12, as the EGADD[0] to the EGADD[10].

Then, the EG control address designating unit 13b outputs the held EGADD[0] to EGADD[10] as the +EG-ADD[0:10] to the history memory 15 and outputs “High” as the +EG-WE. As a result, the EG control address designating unit 13b allows the history memory 15 to store an error bit.

Furthermore, upon reception of the history write request when the CNT[0:1] is [10], the EG control address designating unit 13b allows the EADD[0:10] received from the EG control register 12 to be held in the EGADD[0] to the EGADD[10]. Furthermore, since the +SET becomes “High” and the −RST becomes “High” when the history write request is received, “High” is held in the FE of the set/reset circuit, causing the +EG RTN to be “High.”

The EG control address designating unit. 13b herein computes the exclusive OR of the MADD[0:10] and the +EG-ADD[0:10], thereby allowing the +EG-ADD[0:10] to be compared with the MADD[0:10]. Then, the EG control address designating unit 13b keeps the value of the +EG RTN “High” until the +EG-ADD[0:10] and the MADD[0:10] become the same. That is, each time the history write request is received, the EG control address designating unit 13b compares the +EG-ADD[0:10] with the MADD[0:10] while changing the +EG-ADD[0:10] in increments of one.

Thus, each time the history write request is received, the EG control address designating unit 13b allows error bits to be stored in the storage regions indicated by consecutive history addresses until the +EG-ADD[0:10] and the MADD[0:10] become the same. Then, the EG control address designating unit 13b operates as follows when the +EG-ADD [0:10] and the MADD[0:10] become coincident with each other. That is, the EG control address designating unit 13b ends the writing on the history memory 15 as a result of the output +EG RTN from the set/reset circuit being reset to “Low” since the −RST becomes “Low.”

Now, a description will be made to the operation of the EG control address designating unit 13b reading an error bit out from the history memory 15. For example, the EG control address designating unit 13b receives the history readout request from the JAG 2 when the CNT[0:1] received from the EG control register 12 is “01.”

In such a case, the ED control address designating unit 13b sets, to each FF, the EADD[0:10] which has been preset to the EG control register 12, and outputs the set EADD[0:10] as the +EG-ADD[0:10] to the history memory 15. As a result, the EG control address designating unit 13b can output. the error bit stored in the storage region indicated by the EADD[0:10] from the history memory 15.

Furthermore, upon reception of the history readout request from the JTAG 2 when the CNT[0:1] received from the EG control register 12 is “10,” the E control address designating unit 13b allows the EADD[0:10] to be set to each FF of the up-counter. Furthermore, since the input +SET to the set/reset circuit becomes “High” and the −RST becomes “High,” “High” is held in the FF of the set/reset circuit. Furthermore, the +EG RTN is “High” until the EADD[0:10] and the MADD[0:10] becomes coincident with each other.

As a result, each time the history readout request is received from the JTAG 2, the EG control address designating unit 13b transmits, to the history memory 15, the +EG-ADD[0:10] being changed in increments of one until the EADD[0:10] and the MADD[0:10] become coincident with each other. Subsequently, when the EADD[0:10] and the MADD[0:10] become coincident with each other, the EG control address designating unit 13b ends the operation of reading out from the history memory as a result of the +EG RTN being reset to “Low” since the −RST becomes “Low.”

Furthermore, when the CNT[0:1] is “00,” the EG control address designating unit 13b neither allows the up-counter to operate nor outputs the +EG-WE. Thus, when the CNT[0:1] is “00,” the EG control address designating unit 13b does not output an error bit from the history memory 15.

Furthermore, when the CNT[0:1] is “11,” the EG control address designating unit 13b receives the history write request or the history readout request from the JTAG 2, thereby resetting the up-counter. More specifically, the EG control address designating unit 13b resets, to “Low,” all the values of the EGADD[0] to the EGADD[10] held by each FF, thus initializing the +EG-ADD[0:10].

Referring back to FIG. 1, the selector 14 receives the JDR[0:31] from the JTAG 2, receives the H-WD[0:31] from the data communication control circuit 11, and receives the EN[0] from the EG control register 12. Then, the selector 14 transmits the H-WD[0:31] as the WD[0:31] to the history memory 15 when the EN[0] is “Low,” and transmits the JDR[0:31] as the WD[0:31] to the history memory 15 when the EN[0]is “High.”

The history memory 15 stores as a history the DATA[0:31] to be transmitted to the memory 4 during other than the test of the RAE of the memory 4 in order to facilitate the determination of the error cause at the time of occurrence of an error. Furthermore, the history memory 15 stores an error bit during the test of the RAS of the memory 4. For example, the history memory 15 is a Static Random Access Memory (SRAM) which is capable of storing 2048 words of 32-bit data.

More specifically, the history memory 15 receives the +ADD[0:10] and the −WE from the address counter 13 and receives the WD[0:31] from the selector 14. Then, the history memory 15 executes the following processing in every clock cycle of the −CLK signal.

That is, when the −WE received from the address counter 13 is “Low,” the history memory 15 stores the WD[0:31] received from the selector 14 in the storage region indicated by the +ADD[0:10]received from the address counter 13. Furthermore, when the −WE received from the address counter 13 is “High,” the history memory 15 outputs, as the RD[0:31], the data stored in the storage region indicated by the +ADD[0:10].

When the EN[0] is “Low,” the RD[0:31] outputted by the history memory 15 is herein transferred to the JTAG 2 by way of the path (A) illustrated in FIG. 1. Furthermore, when the EN[0] is “High,” the RD[0:31] is transferred to the EOR gate 16 by way of the path (F) illustrated in FIG. 1.

Now, a description will be made to the contents of the WD[0:31]stored in the history memory 15 and the contents of the RD[0:31] outputted by the history memory 15. For example, when the EN[0] is “Low,” the history memory 15 receives, as the WD[0:31], the H-WD[0:31] outputted by the data communication control circuit 11. Furthermore, the history memory 15 receives the +H-ADD[0:10] as the +ADD[0:10] from the address counter 13 and receives the +H-WE as the −WE.

As a result, when the EN[0] is “Low,” the history memory 15 stores, as history information, the H-WD[0:31] outputted by the data communication control circuit 11 in the storage region indicated by the +H-ADD[0:10].

Furthermore, in every clock cycle of the −CLK signal, the history memory 15 receives, as a new +H-ADD[0:10], a value obtained by incrementing the previously received +H-ADD[0:10] by one. Thus, the history memory 15 stores multiple pieces of H-WD[0:31] outputted by the data communication control circuit 11 in the storage regions indicated by consecutive history addresses.

Furthermore, when the EN[0] is “Low” and the history freeze request is issued from the STAG 2, the history memory 15 receives “High” as the −WE from the address counter 13. Then, each time the history readout request is issued from the STAG 2, the history memory 15 transmits the history stored in the storage region indicated by the +ADD[0:10] received from the address counter 13 to the STAG 2 by way of the path (A) illustrated in FIG. 1. Furthermore, when the EN[0] is “Low” and the freeze release request is issued from the STAG 2, the history memory 15 receives “Low” as the −WE and thus starts to write a history again.

Furthermore, when the EN [0] is “High,” the history memory 15 receives, as the WD[0:31], the JDR[0:31] issued by the JTAG 2. Furthermore, the history memory 15 receives the +EG-ADD[0:10] as the +ADD[0:10] from the address counter 13 and receives the +EG-WE as the −WE.

As a result, when the EN[0] is “High” and the history write request is issued by the JTAG 2, the history memory 15 stores the JDR[0:31] in the storage region indicated by the +EG-ADD[0:10] received from the address counter 13. That is, the history memory 15 stores an error bit in the storage region indicated by the +EG-ADD[0:10]. Furthermore, when the CNT[0:1] is “10,” the history memory 15 receives the +EG-ADD[0:10] incremented by one each time the history write request is issued by the JTAG 2. Thus, the history memory 15 stores multiple patterns of bits in the storage region indicated by consecutive history addresses.

Furthermore, when the EN[0] Is “High” and the history readout request is issued by the JTAG 2, the history memory 15 receives the +EG-ADD[0:10] and receives “High” as the WE from the address counter 13. Thus, the history memory 15 transmits, as the RD[0:31], the error bit stored in the storage region indicated by the +EG-ADD[0:10] received from the address counter 13 to the EOR gate 16 by way of the path (B) illustrated in FIG. 1.

Furthermore, each time the history readout request is issued by the JTAG 2, the history memory 15 receives the +EG-ADD[0:10] incremented by one. Thus, the history memory 15 continually transmits multiple patterns of bits stored in the storage regions indicated by consecutive history addresses to the EOR gate 16.

Note that FIG. 1 omits the illustration of a circuit for achieving the function of changing the destination of the RD[0:31] depending en the value of the EN[0]. For example, this circuit acquires the EN[0] outputted by the EG control register 12 and when the EN[0] is “Low,” outputs the RD[0:31] to the path (A) illustrated in FIG. 1. Furthermore, when the EN[0] is “High,” this circuit outputs the RD[0:31] to the path (B) illustrated in FIG. 1.

The EOR gate 16 transmits, to the memory 4 as new DATA[0:31], the exclusive OR of the DATA[0:31] generated by the data communication control circuit 11 and the RD[0:31] outputted from the history memory 15. That is, of each bit of the DATA[0:31], the EOR gate 16 inverts the bit at the level at which “High” is stored in the RD[0:31].

For example, when the 10th, 23rd, and 31st bits among respective bits of the RD[0:31] are “High,” the EOR gate 16 inverts the 10th, 23rd, and 31st bits of the DATA[0:31]. Then, the EOR gate 16 transmits the bit-inverted DATA[0:31] to the memory 4.

The FCC determination unit 5 included in the memory 4 receives the DATA[0:31] and the CB[0:6] from the memory controller 1. Then, the FCC determination unit 5 computes the CE[0:6] from the received DATA[0:31], and then detects the difference between the computed CB[0:6] and the received CB[0:6], thereby detecting the error of the DATA[0:31].

Here, to perform the test of evaluating the RAS of the memory 4, the memory controller 1 transmits the DATA[0:31] with a pseudo error inserted therein by inverting each bit of the DATA[0:31] depending on the bits of the RD[0:31]. Thus, while the test of evaluating the RAS is being executed, the ECC determination unit 5 detects an error because a difference occurs between the CB[0:6] computed from the DATA[0:31] and the received CB[0:6]. Then, the ECC determination unit 5 stores the details of the detected. error in the error log storage unit 6 and outputs the information that the error has been detected.

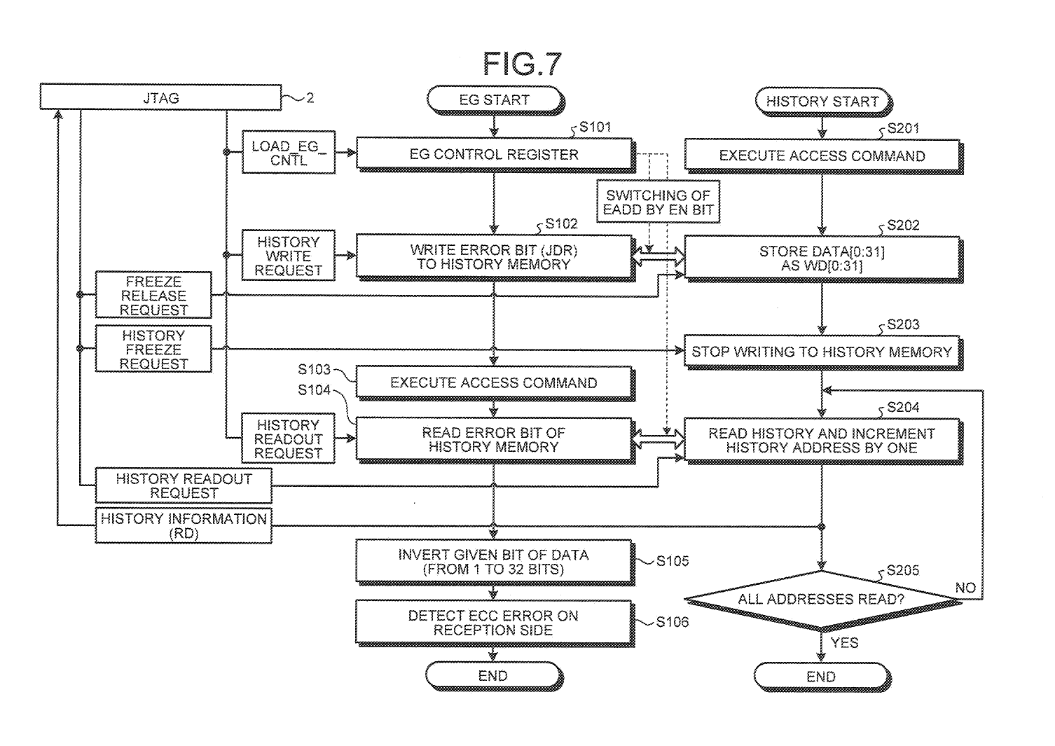

Now, referring to FIG. 7, a description will be made to an example of the flow of a process executed by the memory controller 1. FIG. 7 is an explanatory flowchart. illustrating an example of the flow of a process executed by the memory controller 1 according to the first embodiment. Note that FIG. 7 illustrates the flow of a process for the memory controller 1 to insert a pseudo error into the DATA[0:31] and the flow of a process for the memory controller 1 to store a history. First, referring to FIG. 7, a description will be made to the flow of the process for the memory controller 1 to insert a pseudo error into the DATA[0:31].

First, when the JTAG 2 has issued a LOAD_EG_CNTL, the memory controller 1 stores the EN[0], the CNT[0:1], an EADD, and the MASS in the EG control register 12 (step S101). Next, the memory controller 1 stores a plurality of bits indicative of multiple patterns of pseudo error in the respective consecutive history address storage regions of the history memory 15 (step S102).

Furthermore, the history memory 15 executes an access command (step S103), and reads the error bits from the storage regions indicated by the consecutive history addresses in response to the history readout request issued from the JTAG 2 (step S104). Then, depending on the read bits, the history memory 15 inverts a given bit of the DATA[0:31] (step S105), and transmits the resulting DATA[0:31] to the memory 4. The memory 4 detects the FCC error from the received DATA[0:31] (step S106).

Now, a description will be made to the flow of the process for the memory controller 1 to store a history. First, the memory controller 1 executes an access command (step S201), and stores the DATA[0:31] transmitted to the memory, as the WD[0:31] in the history memory 15 (step S202).

Furthermore, when the history freeze request is issued by the JTAG 2, the memory controller 1 stops writing on the history memory (step S203), and reads the WD[0:31] stored in the history memory 15 (step S204). At this time, the memory controller 1 increments by one the history address being read.

Furthermore, the memory controller 1 determines whether the histories of all the addresses have been read (step S205), and exits the process when it is determined that the histories of all the addresses have been read (YES in step S205). On the other hand, when it is determined that the histories of all the addresses have not yet been read (NO in step S205), the memory controller 1 reads a history and increments by one the history address being read (step S204).

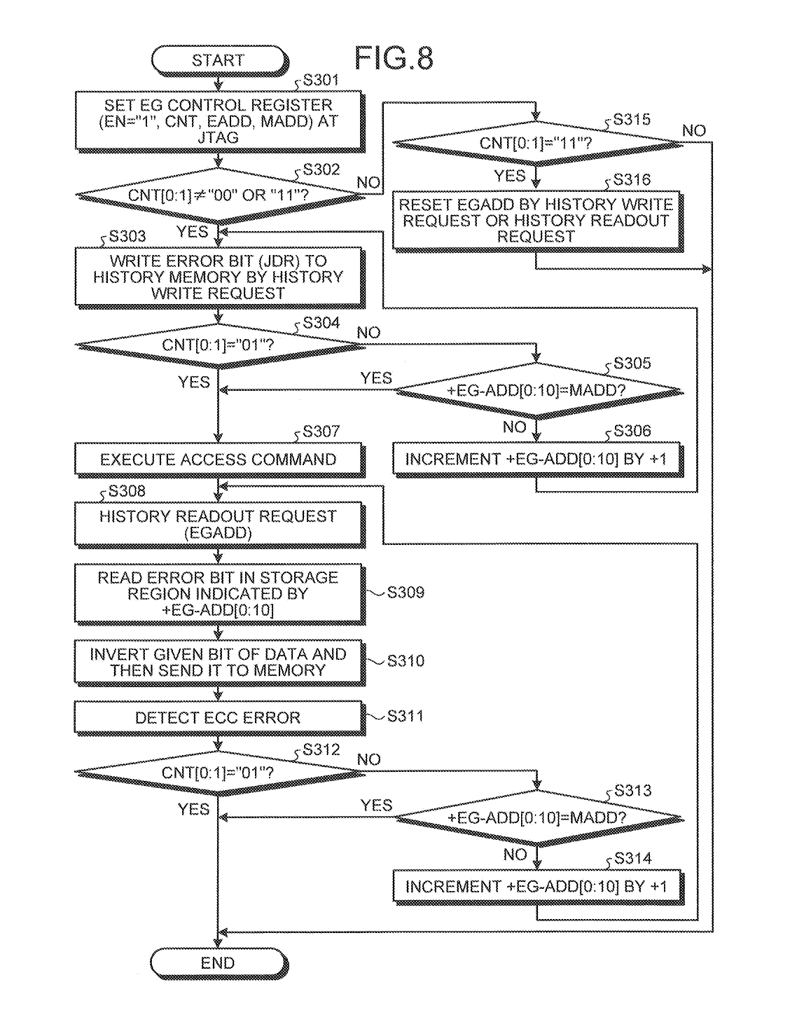

Now referring to FIG. 8, a description will made to an example of the flow of a process for the memory controller 1 to continually insert multiple patterns of pseudo error. FIG. 8 is an explanatory flowchart illustrating an example of a process for the memory controller 1 according to the first embodiment to continually insert multiple patterns of pseudo error. First, the memory controller 1 issues the JTAG command from the JTAG 2 and sets the EN[0], the CNT[0:1], the EADD[0:10], and the MADD[0:10] of the EG control register 12 (step S301). At this time, it is assumed that “High” is set to the EN[0] of the EG control register 12.

In such a case, the memory controller 1 determines whether the CNT[0:1] is other than “00” or “11” (step S302). Then, when the CNT[0:1] is determined to be other than [00] or [11] (YES in step S302), the memory controller 1 executes the following processing. That is when the history write request is issued, the memory controller 1 writes the error bit (JDR[0:31]) onto the history memory 15 (step S303).

Next, the memory controller 1 determines whether the CNT[0:1] is “01” (step S304). Then, when the CNT[0:1] is determined to be not “01” (NO in step S304), the memory controller 1 determines whether the +EG-ADD[0:10] and the MADD[0:10] are coincident with each other (step S305).

Then, when the +EG-ADD[0:10] and the MADD[0:10] are determined to be not coincident with each other (NO in step S305), the memory controller 1 increments the +EG_{ADD[}0:10] by one (step S306). Then, when a new history write request is issued, the memory controller 1 stores the error bit (JDR[0:31]) in the storage region indicated by the +EG-ADD[0:10] incremented by one in step S306 (step S303).

On the other hand, when the CNT[0:1] is “01” (YES in step S304) or when the +EG-ADD[0:10] is coincident with the MADD[0:10] (YES in step S305), the memory controller 1 ends storing error bits. Then, in response to the execution of the access command (step S307), the memory controller 1 executes the following processing.

That is, when the history readout request is issued (step S308), the memory controller 1 reads the error bit in the storage region indicated by the +EG-ADD[0:10] (step S309). Then, on the basis of the error bit having been read, the memory controller 1 inverts the bits of the DATA[0:31], and then transmits the bit inverted DATA[0:31] to the memory 4 (step S310). Subsequently, the memory 4 detects an ECC error (step S311).

Furthermore, after having transmitted the DATA[0:31] to the memory 4, the memory controller 1 determines whether the CNT[0:1] is “01” (step S312). Then, when the CNT[0:1] is determined to be not “01,” that is, when the CNT[0:1] is determined to be “10” (NO in step S312), the memory controller 1 executes the following processing.

That is, the memory controller 1 determines whether the +EG-ADD[0:10] is coincident, with the MADD[0:10] (step S313). Then, when the +EG-ADD[0:10] is determined to be not coincident with the MADD[0:10] (NO in step S313), the memory controller 1 increments the +EG-ADD[0:10] by +1 (step S314). Then, the memory controller 1 executes the following processing by issuing the history readout request again. That is, the memory controller 1 transmits, to the memory 4, the DATA[0:31] into which the error bit in the storage region indicated by the incremented +EG-ADD[0:10] has been inserted (steps S308 to S311).

On the other hand, when the CNT[0:1] is determined to be “01” (YES in step S312) or when the +EG-ADD“0:10” is coincident with the MADD[0:10] (YES in step S313), the memory controller 1 exits the process.

Furthermore, when it is determined that the CNT[0:1] is not [00] or [11] (NO in step S302), the memory controller 1 determines whether the CNT[0:1] is “11” (step S315). Then, when the CNT[0:1] is determined to be [11] (YES in step S315), the memory controller 1 resets the EGADD by the history write request or the history readout request (step S316) and exits the process. Furthermore, when it is determined that the CNT[0:1] is not [11] (NO in step S315), the memory controller 1 exits the process without making any change.

### Effects of the First Embodiment

As described above, the memory controller 1 has the data communication control circuit 11 that produces the DATA[0:31] to be transmitted to the memory 4. The memory controller 1 also has the EG control register 12 that outputs the EN[0] indicative of whether to enable a test and the CNT[0:1] to be used for controlling the test. The memory controller 1 further has the history memory 15 that stores histories during other than the test and stores, during the test, an error bit indicative of a pattern of pseudo error to be inserted into the DATA[0:31]. Furthermore, the memory controller 1 has the address counter 13 which produces the +EG-ADD[0:10] on the basis of the EN[0] and the CNT[0:1] during the test.

Then, when the EN[0] is “High,” the memory controller 1 reads the error bit stored in the history memory 15, and depending on the read error bit, inserts a pseudo error into the DATA[0:31] generated by the data communication control circuit 11. Subsequently, the memory controller 1 transmits the DATA[0:31] with the pseudo error inserted therein to the memory 4.

Thus, the memory controller 1 can continually verify the RAS of the memory 4. That is, the memory controller 1 can store multiple patterns of error bits in the history memory 15, and during the test, insert each pattern of pseudo error into the DATA[0:31] on the basis of each error bit. Thus, the memory controller 1 can continually verify the RAS of the memory 4 for the multiple patterns of pseudo error.

Furthermore, the memory controller 1 allows the history memory 15 to store multiple patterns of error bits. Thus, the memory controller 1 can perform the test of verifying the RAS of the memory 4 for multiple patterns of pseudo error without providing an additional memory for storing new error bits.

Furthermore, the memory controller 1 inserts a pseudo error into the DATA[0:31] by producing the exclusive OR of the DATA[0:31] and the RD[0:31] that is an error bit. Thus, the memory controller 1 can employ a simplified circuit structure to achieve the processing of inserting a pseudo error.

Furthermore, the memory controller 1 allows the history memory 15 to store multiple patterns of error bits. Then, when the CNT[0:1] is “10,” the memory controller 1 allows the address counter 13 to sequentially produce the +EG-ADD[0:10] that in the history address of the storage region in which each error bit is stored. Since this enables various patterns of pseudo error to be continually inserted, the memory controller 1 can completely verify the RAS of the memory 4 in a short time.

Furthermore, when the CNT[0:1] is “10,” the memory controller 1 continually inserts various patterns of pseudo error into the DATA[0:31], while inserting one pattern of pseudo error into the DATA[0:31] when the CNT[0:1] is “01.” Thus, the memory controller 1 can verify the RAS of the memory 4 in a variety of ways as circumstances demand. That is, the memory controller 1 can selectively verify, depending on the circumstances, the RAS using one pseudo error and the RAS using various patterns of pseudo error.

Furthermore, during the test, the memory controller 1 stores, as pseudo failure data in the history memory 15, the JDR[0:31] supplied by the JTAG command. Thus, the memory controller 1 can insert any given pattern of pseudo. error into the DATA[0:31]. That is, the memory controller 1 can arbitrarily set the number and the position of pseudo errors to be inserted. As a result, the memory controller 1 can completely verify the RAS of the memory 4

### Second Embodiment

In the following second embodiment, a description will be made to Memory Access Control (MAC) for transmitting data to a Dual Inline Memory Module (DIMM) having a redundant function.

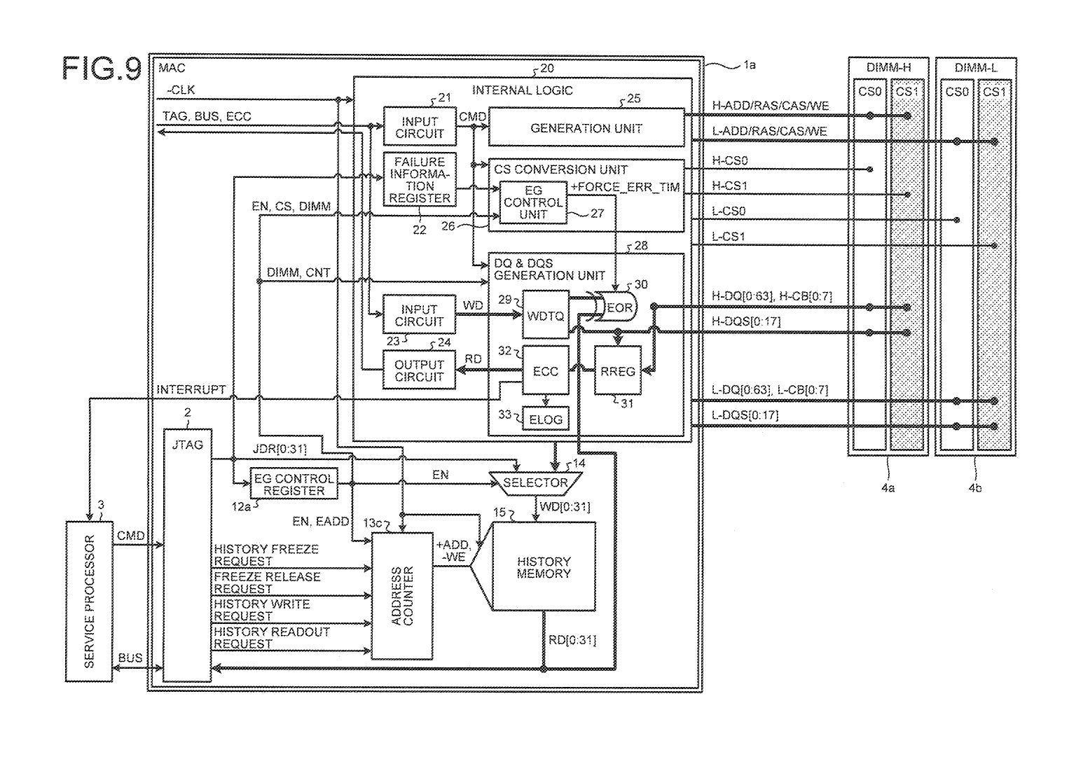

FIG. 9 is an explanatory view illustrating a MAC according to the second embodiment. In the example illustrated in FIG. 9, an MAC 1a has a JTAG 2, an EG control register 12a, an address counter 13c, the selector the history memory 15, and an internal logic 20. On the other hand, the internal logic 20 has an input circuit 21, a failure information register 22, an input circuit 23, an output circuit 24, a generation unit 25, a CS conversion unit 26, an ED control unit 27, and a DQ & DQS generation unit 28.

Furthermore, the DQ & DQS generation unit 28 has Write Data Time Quanta (WDTQ) 29, an FOR gate 30, a Read Register (REED) 31, an FCC 32, and Error LOG (ELOG) 33. Note that the JTAG 2, the service processor 3, the selector 14, and the history memory 15 illustrated in FIG. 9 are assumed to execute the same processing as that of the JTAG 2, the service processor 3, the selector 14, and the history memory 15 according to the first embodiment, and thus will not be repeatedly explained.

such a MAC 1a is connected to two units: a DIMM-H 4a and a DIMM-L 4b. Here, each of the DIMM-H 4a and the DIMM-L 4b is a memory module which is made up of a Double-Data-Rate Synchronous Dynamic Random Access Memory (DDR-SDRAM) or a DDR2-SDRAM. Furthermore, the DIMM-H 4a and the DIMM-L 4b are a DIMM which has a 2-Rank structure with a 72-bit data width that is standardized by the Joint Election Device Engineering Council (JEDEC).

Furthermore, the MAC 1a transmits control signals to the DIMM-H 4a: an H-ADD (Address), a RAS (Row Address Strobe), a CAS (Column Address Strobe), and a WE (Write Enable). Furthermore, the MAC 1a transmits an L-ADD, the RAS, the CAS, and the WE to the DIMM-L 4b.

Furthermore, the MAC 1a transmits an H-CS0 to the CS0 of the DIMM-H 4a, and transmits an H-CS1 to the CS1 of the DIMM-H 4a. Furthermore, the MAC 1a transmits an L-CS0 to the CS0 of the DIMM-L 4b and transmits an L-CS1 to the CS1 of the DIMM-L 4b.

Furthermore, the MAC 1a transmits, to the DIMM-H 4a, a 64-bit H-DC (Data Queue) [0:63], an 8-bit H-CB[0:7], and an 18-bit H-DQS (Data Queue Strobe) [0:17]. Furthermore, the MAC 1a transmits, to the DIMM-L 4b, a 64-bit L-DQ[0:63], an 8-bit L-CB[0:7], and an 18-bit L-DQS[0:17]. Note that the H-DQ[0:63] and the L-DQ[0:63] are a data signal; the H-CB[0:7] and the L-CB[0:7] are a check bit of the data signal; and the H-DQS[0:17] and the L-DQS[0:17] are a data strobe signal.

The DIMM-H 4a has herein a 2-Rank structure with an SDRAM element for receiving the H-CS0 signal and an SDRAM element for receiving the H-CS1 signal. Furthermore, likewise, the DIMM-L 4b also has a 2-Rank structure with an SDRAM element for receiving the L-CS0 signal and an SDRAM element for receiving the L-CS1 signal. Note that in the descriptions that follow, the SDRAM element for receiving the H-CS0 signal and the L-CS0 signal will be denoted as the CS0, while the SDRAM element for receiving the H-CS1 signal and the L-CS1 signal will be denoted as the CS1.

The CS1 included in the DIMM-H 4a is a redundant region of the CS0 included in the DIMM-H 4a. That is, the MAC 1a normally executes memory access only to the CS0 included in the DIMM-H 4a. Then, the MAC 1a executes a rewrite command when a correctable error is detected in the CS0 included in the DIMM-H 4a. That is, the MAC 1a corrects the data in which an error has been detected, and stores the corrected data again in the CS0 included in the DIMM-H 4a.

Furthermore, after having stored the error corrected data again in the CS0 included in the DIMM-H 4a, the MAC 1a executes the following processing when a correctable error is detected again in the CS0 included in the DIMM-H 4a. That is, the MAC 1a determines that a permanent failure has occurred in the CS0 of the DIMM-H 4a and executes redundancy processing for copying all the data stored in the CS0 of the DIMM-H 4a to the CS1.

such a MAC 1a inserts a correctable pseudo error into the H-DQ[0:63] to be transmitted to the DIMM-H 4a and detects the correctable pseudo error from the DIMM-H 4a, thereby verifying the RAS. Furthermore, the MAC 1a inserts a pseudo error again into the data with the detected pseudo. error corrected and detects the pseudo error from the DIMM-H 4a, thereby producing a permanent failure of the DIMM-H 4a in a pseudo manner and verifying whether the redundancy processing of the DIMM-H 4a is properly executed.

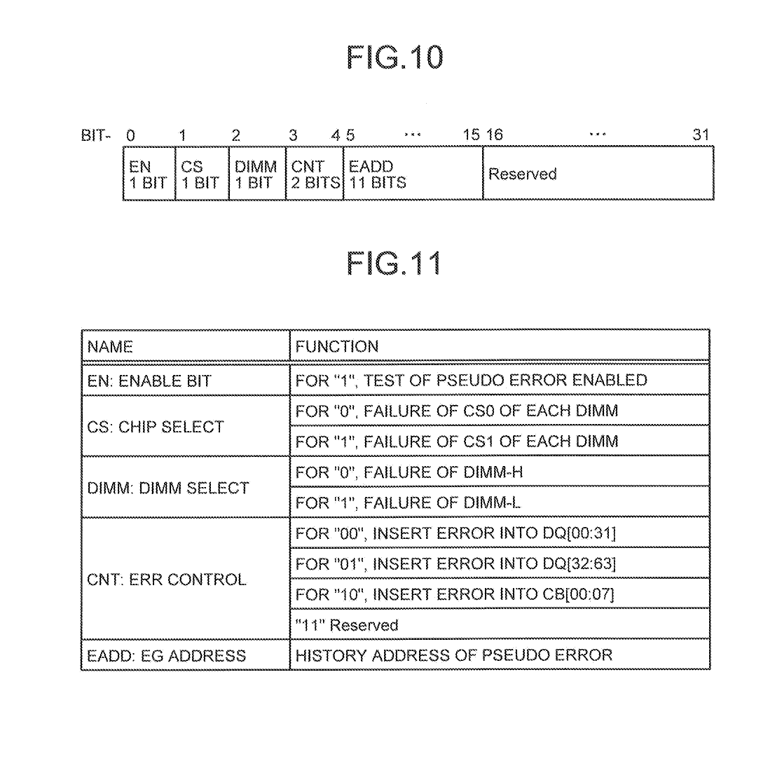

Now, a description will be made to each part included in the MAC 1a. Like the EG control register 12, the EG control register 12a stores the EN[0], the CNT[0:1], and the EADD[0:10]. Now, referring to FIG. 10, a description will be made to the contents of data stored in the EG control register 12a. FIG. 10 is an explanatory view illustrating an example of the EG control register according to the second embodiment.

In the example illustrated in FIG. 10, the EG control register 12a stores the “0th-bit” data of the JDR[0:31] as the EN[0], the “1st-bit” data as CS[0], and the “2nd-bit” data as DIMM[0]. Furthermore, the EG control register 12a stores the “3rd-bit”and the “4th-bit” data as 2-bit CNT[0:1], and stores eleven bits from the “5th-bit” to the “15th-bit” as EADD[0:10]. Note that the “16th-bit” to the “31st-bit” of the JDR[0:31] are stored as a reserved region.

No referring to FIG. 11, a description will be made to each piece of data stored in the EG control register 12a. FIG. 11 is an explanatory view illustrating an example of data stored in the EG control register according to the second embodiment. The EN[0] stored in the EG control register 12a is the information indicative of whether to use a pseudo error to execute the test of evaluating the RAS of each of DIMMs 4a and 4b. In the example illustrated in FIG. 11, the MAC 1a executes the test when the EN[0] is “High,” and does not execute the test when the EN[0] is “Low.”

Furthermore, the CS[0] stored in the EG control register 12a is indicative of on which side, the CS0 or the CS1 included in the DIMM-N 4a and the DIMM-L 4b, the permanent failure is produced in a pseudo manner. For instance, in the example illustrated in FIG. 11, the MAC 1a produces a permanent failure in a pseudo manner on the CS0 side when the CS[0] is “Low,” and produces a permanent failure in a pseudo manner on the CS1 side when the CS[0] is “High.”

On the other hand, the DIMM[0] stored in the EG control register 12a is indicative of on which of the DIMM-H 4a and the DIMM-L 4b a permanent failure is produced in a pseudo manner. For instance, in the example illustrated in FIG. 11, the MAC 1a produces a permanent failure in a pseudo manner on the DIMM-H 4a side when the DIMM[0] is “Low,” and produces a permanent failure in a pseudo manner on the DIMM-L 4b side when the DIMM[0] is “High.”

Furthermore, the CNT[0:1] stored in the EG control register 12a is the information indicative of which signal of the DQ[0:63] signals is inverted. For instance, in the example illustrated in FIG. 11, the MAC 1a inverts the bits included in the range from DQ[0] to DQ[31] of the DQ[0:63] when the CNT[0:1] is “00.” That is, the MAC 1a computes the exclusive OR of each bit of the DQ[00:31] and the error bit, thereby inserting the pseudo error into the range of the DQ[00:31].

Furthermore, for instance, in the example illustrated in FIG. 11, when the CNT[0:1] is “01,” the MAC 1a inverts the bits included in the range from the DQ[32] to DQ[63] of the DQ[0:63]. That is, the MAC 1a computes the exclusive OR of the DQ[32:63] and the error bit, thereby inserting the pseudo error into the range of the DQ[32:63].

Furthermore, for instance, in the example illustrated in FIG. 11, when the CNT[0:1] is “10,” the MAC 1a bit inverts the CB[0:7]. That is, the MAC 1a computes the exclusive OR of the CB[0:7] and the error bit, thereby inserting the pseudo error into the CB[0:7]. Note that in the example illustrated in FIG. 11, the signal to be inverted when the CNT[0:1] is “11” is not specified. That is, in the example illustrated in FIG. 11, the user can arbitrarily determine the signal to be inverted when the CNT[0:1] is other than “11.”

Furthermore, the EADD[0:10] stored in the EG control register 12a is a history address indicative of a storage region in which the pattern of pseudo error to be inserted into the DQ[0:63] or CB[0:7] is stored. That is, the MAC 1a computes the exclusive OR of the error bit stored in the storage region indicated by the EADD[0:10] of the history memory 15 and the DQ[0:63] or CB[0:7], thereby bit-inverting the DQ[0:63] or CB[0:7]. That is, the MAC 1a inserts the pseudo error into the DQ[0:63] or CB[0:7] using the error bit stored in the storage region indicated by the EADD[0:10].

Upon reception of the JDR[0:31] issued by the JTAG 2, such an EG control register 12a stores each bit of the received JDR[0:31] as the EN[0], the CS[0], the DIMM[0], the CNT[0:1], and the EADD[0:10]. Then, the EG control register 12a outputs the EN[0] to the selector 14 and outputs the EN[0] and the EADD[0:10] to the address counter 13c. Furthermore, the EG control register 12a outputs the EN[0], the CS[0], and the DIMM[0] to the EG control unit 27, and transmits the DIMM[0] and the CNT[0:1] to the DQ & DQS generation unit 28.

Like the address counter 13 according to the first embodiment, the address counter 13c receives the history freeze request, the freeze release request, the history write request, and the history readout request from the JTAG 2. Furthermore, the address counter 13c receives the EN[0] and the EADD[0:10] from the EG control register 12a. Then, depending on each of the received requests and the received EN[0] and the EADD[0:10], the address counter generates the +ADD[0:10] and the −WE and then transmits the generated +ADD[0:10] and −WE to the history memory 15.

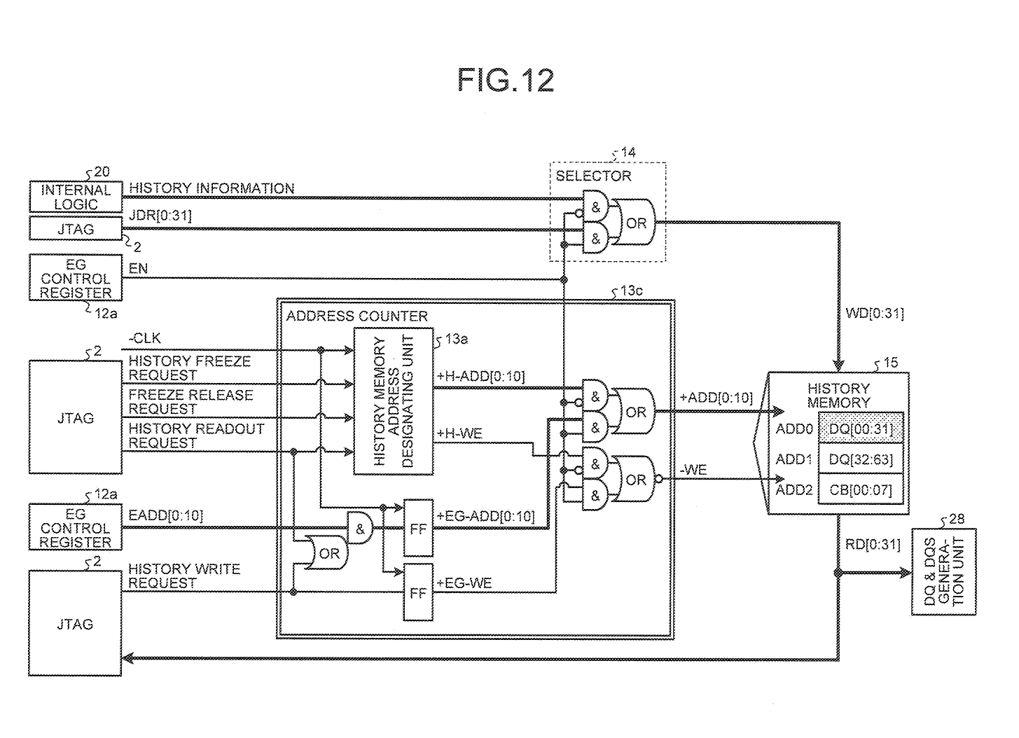

Now, referring to FIG. 12, a description will be made to an example of the address counter 13c. FIG. 12 is an explanatory view illustrating an example of the address counter according to the second embodiment. In the example illustrated in FIG. 12, the address counter 13c has a history memory address designating unit 13a. Note that the history memory address designating unit 13a according to the second embodiment is assumed to execute the same processing as that of the history memory address designating unit 13a according to the first embodiment and thus will not be repeatedly described below.

Furthermore, when having received the history readout request or the history write request, the address counter 13c has an FF which latches the EADD[0:10] of the EG control register 12a and which outputs the latched EADD[0:10] as the +EG-ADD[0:10]. Furthermore, when the history write request is issued, the address counter 13c has an FF which latches the issued history write request and which outputs the latched history write request as the +EG-WE.

when the EN[0] is “Low,” such an address counter 13c outputs, as the +ADD[0:10], the +H-ADD[0:10] outputted by the history memory address designating unit 13a and outputs, as the −WE, the +H-WE outputted by the history memory address designating unit 13a. Furthermore, when the EN[0] is “High,” the address counter 13c outputs, as the +ADD[0:10], the +EG-ADD[0:10] outputted by the FF and outputs the +EG-WE as the −WE.

The history memory 15, like the history memory 15 according to the first embodiment, normally stores, as the WD[0:31] the history information outputted from the internal logic 20, and at the time of occurrence of an error, transmits the stored WD[0:31] to the JTAG 2 as the RD[0:31]. Furthermore, during the test, the history memory 15 stores, as an error bit, the JDR[0:31] acquired from the JTAG 2 in the storage region indicated by the +ADD[0:10] outputted by the address counter 13c, that is, the +EG-ADD[0:10].

More specifically, when the EN[0] is “High” and the −WE is “Low,” the history memory 15 stores the JDR[0:31] in the storage region indicated by the +ADD[0:10]. Furthermore, when the EN[0] is “High” and the −WE is “High,” the history memory 15 transmits, to the DQ & DQE generation unit 28, the error bit stored in the storage region indicated by the +ADD[0:10].

For instance, in the example illustrated in FIG. 12, the history memory 15 stores in the ADD0 the error hit to be inserted into the DQ[0:31], stores in the ADD1 the error bit to be inserted into the DQ[32:63], and stores in the ADD2 the error bit to be inserted into the CB[00:07]. Then, when the −WE is “High,” the history memory 15 transmits the error bit stored in the storage region indicated by the +ADD[0:10] to the DQ & DOS generation unit 28.

Referring back to FIG. 9, a description will be made to each of the parts 21 to 33 included in the internal logic 20. The input circuit 21 receives the TAG, the BUS, and the ECC which are an interface signal transmitted by an access command. Then, the input circuit 21 outputs the CMD (command) signal based on the received interface signal to the generation unit 25, the CS conversion unit 26, and the DQ & DOS generation unit 28.

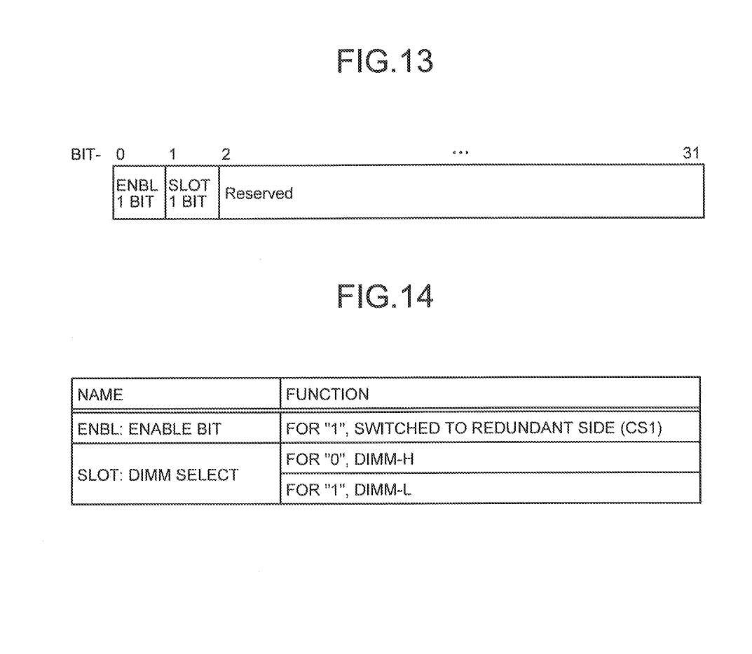

The failure information register 22 stores information indicative of the presence or absence of a failure occurring in the DIMM-H 4a and the DIMM-L 4b. Now, referring to a drawing, a description will be made to an example of information to be stored in the failure information register 22. FIG. 13 is an explanatory view illustrating an example of the failure information register according to the second embodiment. In the example illustrated in FIG. 13, of the JDR “0:31” issued by the JTAG 2, the failure information register 22 stores the [0]th hit as the ENBL (Enable Bit) [0] and stores the [1] st bit as the SLOT (DIMM Select) [0]. Then, the failure information register 22 transmits the stored ENBL[0] and SLOT[0] to the EG control unit 27 included in the CS conversion unit 26.

FIG. 14 is an explanatory view illustrating an example, of information stored in the failure information register according to the second embodiment. For example, the ENBL[0] is information indicative of a storage region to be used among the CS0 and the CS1 included in the DIMM-H 4a and the DIMM-L 4b. For example, when the ENBL[0] is “High,” the MAC 1a transfers the data of the CS0 included in the DIMM-H 4a and the DIMM-L 4b to the CS1 or the redundant system. That is, the MAC 1a switches the storage region to be used from the CS0 to the CS1.

Furthermore, the SLOT[0] is information indicative of the DIMM in which a permanent failure has occurred. For example, the MAC 1a determines that a permanent failure has occurred in the DIMM-H 4a when the SLOT[0] is “Low,” while determining that a permanent failure has occurred in the DIMM-L 4b when the SLOT[0] is “High.”

The input circuit 23 receives an interface signal transmitted by an access command, and in response to the received interface signal, generates WD (Write Data) to be written into the DIMM-H 4a or the DIMM-L 4b and then transmits the generated WD to the WDTQ 29. The output circuit 24 receives, from the ECC 32, the RD (Read Data) read from the DIMM-H 4a or the DIMM-L 4b and sends out the received RD on the interface signal.

The generation unit 25 receives the CMD from the input circuit 21. Then, in response to the received CMD, the generation unit 25 transmits the H-ADD, the RAS, the CAS, and the WE to the DIMM-H 4a. Furthermore, in response to the received CMD, the generation unit 25 transmits the L-ADD, the RAS, the CAS, and the WE to the DIMM-L 4b.

The CS conversion unit 26 receives the ENBL[0] and the SLOT[0] from the failure information register 22 and receives the EN[0], the CS[0], and the DIMM[0] from the EG control register 12a. Then, on the basis of the received SLOT[0], EN[0], CS[0], and DIMM[0], the CS conversion unit 26 produces a timing signal or a +FORCE_ERR_TIM that provides bit inversion control to a DQ signal. Subsequently, the CS conversion unit 26 transmits the generated +FORCE_ERR_TIM to an EOR gate 30 of the DQ & DQS generation unit 28.

Furthermore, on the basis of the received ENBL[0], the CS conversion unit 26 generates the H-CS0 and the L-CS0 or the H-CS1 and the L-CS1, and transmits the generated H-CS0 and L-CS0 or H-CS1 and L-CS1 to the DIMM-H 4a and the DIMM-L 4b.

On the basis of the received SLOT[0], EN[0], CS[0], and DIMM[0], the EG control unit 27 produces the +FORCE_ERR_TIM or a timing signal for providing bit inversion control to the DQ signal. Then, the EG control unit 27 transmits the generated +FORCE_ERR_TIM to the EOR gate 30.

The WDTQ 29 is a buffer for receiving the WD from the input circuit 23 and writing the received WD to the DIMM-H 4a and the DIMM-L 4b. More specifically, when having received the WD from the input circuit 23, the WDTQ 29 holds the received WD. Then, to the EOR gate 30, the WDTQ 29 outputs the +WDTQ[0:63] storing the received WD and outputs the H-DQS[0:17] and the L-DQS[0:17] which are a data strobe signal. Note that in the descriptions that follow, the WD to be written to the DIMM-H 4a is denoted as +WDTQ_H[0:63], and the WD to be written to the DIMM-L 4b as +WDTQ_L[0:63].

The FOR gate 30 receives the +WDTQ[0:63] from the WDTQ 29 and receives the RD[0:31] from the history memory 15. Then, at the timing at which the +FORCE_ERR_TIM is received from the EG control unit 27, the EOR gate, 30 outputs the exclusive OR of the +WDTQ[0:63] and the RD[0:31] as the H-DQ[0:63] or the L-DQ[0:63].

The RREG 31 holds the H-DQ[0:63] and the H-CB[0:7], which have been outputted from the DIMM-H 4a during memory readout, at the timing of each of the rise or falling edge of the H-DQS[0:17] outputted in conjunction therewith. Furthermore, the RREG 31 holds the L-DQ[0:63] and the L-CB[0:7], which have been outputted from the DIMM-L 4b during memory readout, at the timing of each of the rise or falling edge of the L-DQS[0:17] outputted in conjunction therewith.

The EGO 32 checks the ECC of the H-DQ[0:63], the H-CB[0:7], the L-DQ[0:63], and the L-CB[0:7] which are held by the RREG 31, and thereby detects an error. Then, when a correctable error (CE) has been detected, the ECC 32 corrects the detected error, and then transmits the corrected H-DQ[0:63] and L-DQ[0:63] as the RD to the output circuit 24. Furthermore, the ECC 32 notifies the service processor 3 by an interrupt signal that a correctable error has been detected.

On the other hand, when an uncorrectable error (UE) has been detected, the ECC 32 transmits a special pattern of RD to the output circuit. 24 and stores the to information of the detected error in the ELOG 33. Note that the ELOG 33 is a storage unit for storing detailed log information on an error detected by the ECC.

When having received such an interrupt signal transmitted by the ECC 32, the service processor 3 collects the detailed log information stored in the ELOG 33 to perform error analysis. Then, when a correctable error continually occurs again after the rewrite command has been executed, the service processor 3 determines that the DIMM has failed and then executes the redundancy process for transferring data from the CS0 to the CS1.

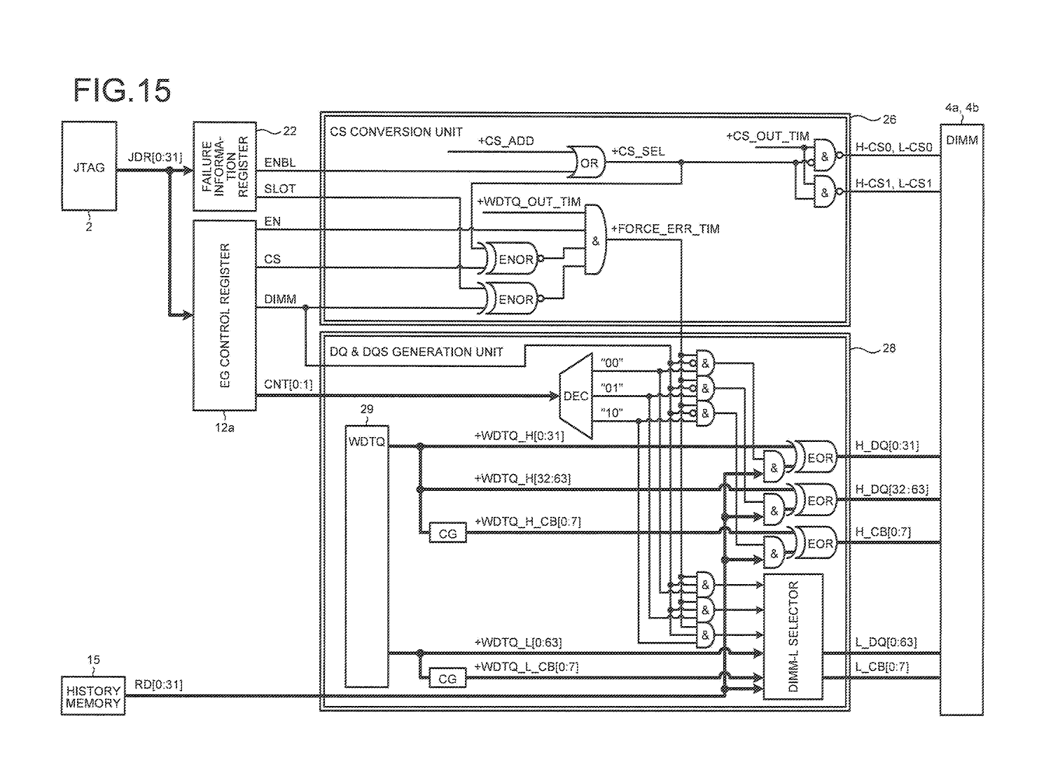

Now, referring to FIG. 15, a description will be made to an example of inverting the bits of the H-DQ[0:63] or the L-DQ[0:63] by the CS conversion unit 26 and the DQ & DQS generation unit 28. FIG. 15 is an explanatory view illustrating an example of a circuit for bit inversion by a MAC according to the second embodiment. Note that in the example illustrated in FIG. 15, it is assumed that the MAC 1a is set by the JTAG command “0:31” so that the SLOT[0] and the DIMM[0] are coincident with each other. at the time of verifying the RAS.

First, a description will be made to the process executed by the CS conversion unit 26. For instance, in the example illustrated in FIG. 15, the CS conversion unit 26 converts the logical OR of the ENBL[0] received from the failure information register 22 and the CS address (+CS_ADD) of an access command into a +CS_SL. Then, the CS conversion unit 26 compares the +CS_SEL with the CS[0] received from the EG control register 12a, and compares the SLOT[0] received from the failure information register 22 with the DIMM[0] received from the EG control register 12a.

Then, the CS conversion unit 26 executes the following processing when the +CS_SELL is coincident with the CS[0], the SLOT[0] is coincident with the DIMM[0], and the EN[0] is enabled, i.e., “High.” That is, the CS conversion unit 26 issues the +FORCE_ERR_TIM according to the timing at which a +WDTQ_OUT_TIM is issued.

Furthermore, the CS conversion unit 26 enables the CS0 or CS1 element of the DIMM-H 4a and the CS0 or CS1 element of the DIMM-L 4b according to the select logic with a +CS-OUT TIM indicative of the timing at which each CS signal is transmitted. For example, during a normal CS access command, the CS conversion unit 26 enables either the CS0 or CS1 memory element that has been selected by the +CS_ADD. Furthermore, to switch between the memory elements, the CS conversion unit 26 always enables the CS1 memory element because the ENBL[0] is “High.”

Now, a description will be made to the process executed by the DQ & DOS generation unit 28. For instance, in the example illustrated in FIG. 15, the WDTQ 29 separates the +WDTQ_H[0:63] into a +WDTQ_H[0:31] and a +WDTQ_H[32:63] for output. Furthermore, the DQ & DQS generation unit 28 uses a Check bit Generator (CG) so as to produce a check bit, i.e., a +WDTQ_H_CB[0:7] from the +WDTQ_H[0:63].

Furthermore, the DQ & DOS generation unit 28 determines a signal into which the RD[0:31] received from the history memory 15, i.e., an error bit is inserted, depending on the value of the CNT[0:1] received from the EG control register 12a. More specifically, the DQ & DQS generation unit 28 enters the +WDTQ_H[0:31], a +WDTQ_H[3.2:63], and the +WDTQ_H_CB[0:7] of the +WDTQ_H[0:63] to the separate respective EOR gates. Then, when the DIMM[0] is “Low,” the DQ & DQS generation unit 28 enters the RD[0:31] to the EOR gate associated with the CNT[0:1] at the timing at which the +FORCE_ERR_TIM is enabled.

In other words, when the CNT[0:1] is “00,” the DQ & DQS generation unit 28 computes the exclusive OR of the +WDTQ_H[0:31] and the RD[0:31]. Furthermore, when the CNT[0:1] is [01], the DQ & DQS generation unit 28 computes the exclusive OR of a +WDTQ_H[32:63] and the RD[0:31]. Furthermore, when the CNT[0:1] is [10], the DQ & DQS generation unit 28 computes the exclusive OR of the +WDTQ_H_CB[0:7] and the RD[0:31].

Then, the DQ & DQS generation unit 28 outputs the +WDTQ_H[0:31] or the exclusive OR of the +WDTQ_H[0:31] and the RD[0:31] as an H DQ[0:31]. Furthermore, the DQ & DQS generation unit 28 outputs the +WDTQ_H[32:63] or the exclusive OR of the +WDTQ_H[32:63] and the RD[0:31] as an H_DQ[32:63]. Furthermore, the DQ & DQS generation unit 28 outputs the +WDTQ_H_CB[0:7] or the exclusive OR of the +WDTQ_H_CB[0:7] and the RD[0:31] as an H_CB[0:7].

Note that the DQ & DQS generation unit 28 has a DIMM-L selector which executes the same processing as the aforementioned one on the data to be transmitted to the DIMM-L 4b, i.e., on the +WDTQ_L[0:63] and a +WDTQ_L_CB[0:7]. When the DIMM[0] is “High,” the DIMM-L selector executes the same processing as the one for inverting the bits of the +WDTQ_H[0:63] or the +WDTQ_H_CB[0:7]. Then, the DIMM-L selector outputs an L_DQ[0:63] and an L_CB[0:7].

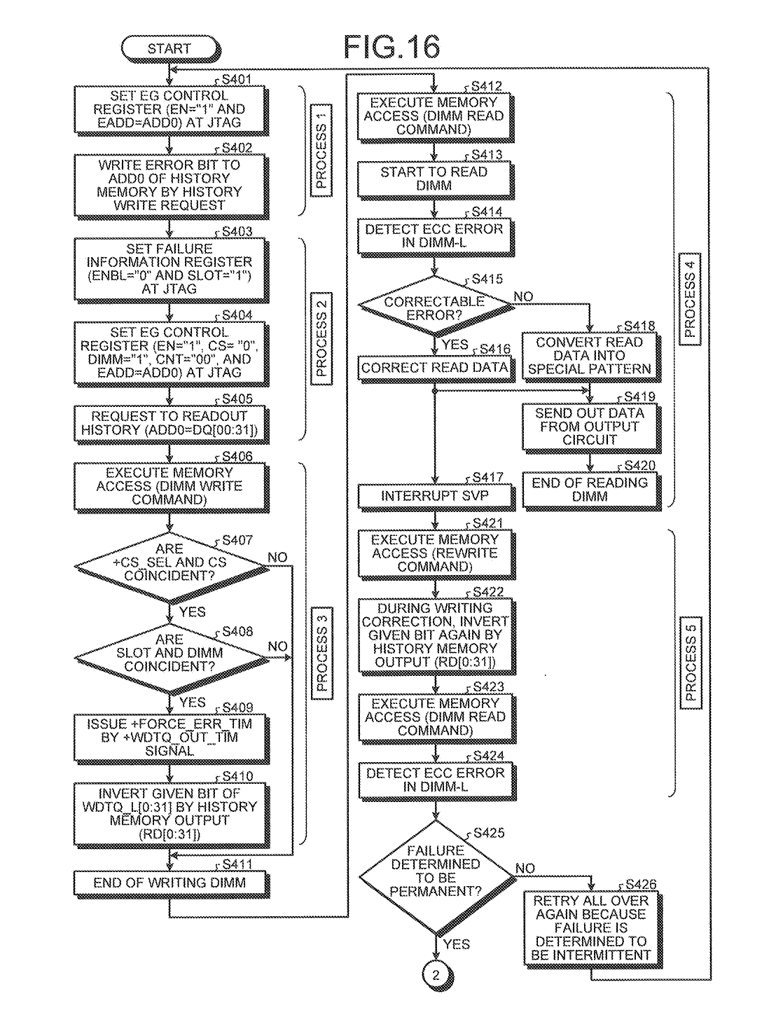

Now, referring to the flowcharts, a description will be made to the flow of a process for the MAC 1a to insert a pseudo error into the DQ signal; the flow of a process for determining that a permanent failure has occurred in the DIMM-H 4a; and the flow of a redundancy process for copying the data of the CS0 to the CS1. First, referring to FIG. 16, a description will be made to the flow of the process for the MAC 1a to insert a pseudo error into the DQ signal, and the flow of the process for determining that a permanent failure has occurred in the DIMM-H 4a.

FIG. 16 is an explanatory first flowchart illustrating the flow of a process executed by a MAC according to the second embodiment. First, in the example illustrated in FIG. 16, using the JTAG command, the MAC 1a sets the EN[0]=1 (i.e., “High”) and the EADD[0:10]=ADD0 to the EG control register 12a (step S401). Now, using the history write request, the MAC its writes an error bit to the ADD0 of the history memory 15 (step S402). Note that the MAC 1a executes the steps S401 and S402 as Process 1.

Now, using the JTAG command, the MAC 1a sets the ENBL[0]=0 (i.e., “Low”) and the SLOT[0]=1 to the failure information register 22 (step S403). Then, using the JTAG command, the MAC 1a sets the EN[0]=1, the CS[0]=“Low,” the DIMM[01]=“1,” the CNT[0:1]=“00,” and the EADD[0:10]=ADD0 to the EG control register 12a (step S404). Then, the MAC 1a issues the history readout request, thereby reading the error bit to be inserted into the DQ[00:31] stored in the ADD0 of the history memory 15 (step S405).

Note that the MAC 1a executes the steps S403 to S405 as Process 2. That is, the MAC 1a executes Process 2, thereby determining that a pseudo failure is produced on the DIMM-L 4b side and reads the error bit from the history memory 15.

Then, the MAC 1a requests memory access to the DIMM-L 4b, that is, issues a data write request (step S406). Then, the MAC 1a determines whether the +CS_SEL and the CS[0] are coincident with each other (step S407). If they are coincident with each other (YES in step S407), the MAC 1a determines whether the SLOT[0] and the DIMM[0] are coincident with each other (step S408).

Then, if it is determined that the SLOT[0] and the DIMM[0] are coincident with each other (YES in step S408), the MAC 1a issues the +FORCE_ERR_TIM at the timing indicated by the +WDTQ_OUT_TIM signal (step S409). Next, the MAC 1a performs bit inversion by computing the exclusive OR of a +WDTQ_L[0:31] and the RD[0:31] outputted by the history memory 15 (step S410). Subsequently, the MAC 1a outputs the bit-inverted +WDTQ_L “0:31,” that is, a DQ_L[0:31] to the CS0 of the DIMM-L 4b, thus ending the writing on the SIMM (step S411).

On the other hand, when a +CS_SEL and the CS[0] are not coincident with each other (NO in step S407), the MAC 1a does not perform bit inversion, but outputs the DQ_L[0:31] to the CS0 of the DIMM-L 4b (step S411). Furthermore, when the SLOT[0] and the DIMM[0] are not coincident with each other (NO in step S408), the MAC 1a does not perform bit inversion, but outputs the DQ_L[0:31] to the DIMM-L 4b (step S411).

Note that the MAC 1a executes the steps S406 to S411 as Process 3. That is, the MAC 1a executes Process 3, thereby transmitting the DQ signal with a pseudo error inserted therein to the DIMM.

Now, the MAC 1a executes memory access so as to read the data stored in the DIMM-D 4b (step S412), and reads a DQ_L[0:63] from the DIMM-L 4b (step S413). Next, the MAC 1a detects an ECC error using the ECC 32 (step S414). Then, the MAC 1a determines whether the detected error is correctable (step S415).

Next, if it is determined that the detected error is correctable (YES in step S415), the MAC 1a corrects the read data (step S416). Then, the MAC 1a transmits an interrupt signal to the service processor 3 indicative of the detection of a correctable error (step S417).

On the other hand, if it is determined that the detected error is not correctable (NO in step S415), the MAC 1a converts the read data into a special pattern of data (step S418). Then, the MAC 1a outputs the special pattern of data (step S419), and then ends the reading out from the DIMM (step S420). Note that the MAC 1a executes the steps S412 to S420 as Process 4. That is, the MAC 1a executes Process 4, thereby detecting the error from the DIMM-L 4b.

Next, the MAC 1a executes memory access indicative of rewriting correctable data (step S421). That is, the MAC 1a rewrites the data corrected in step S416 to the DIMM-L 4b. Furthermore, when writing the corrected data, the MAC 1a inverts bits of the data again using the RD[0:31] outputted by the history memory 15 (step S427).

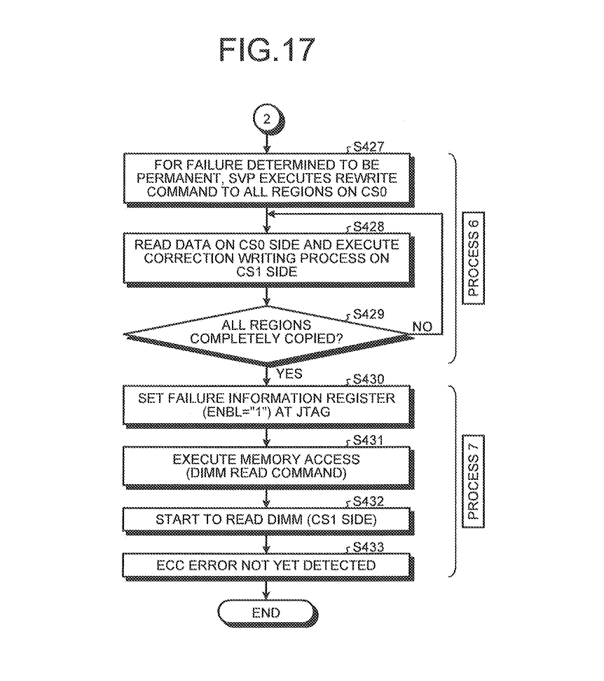

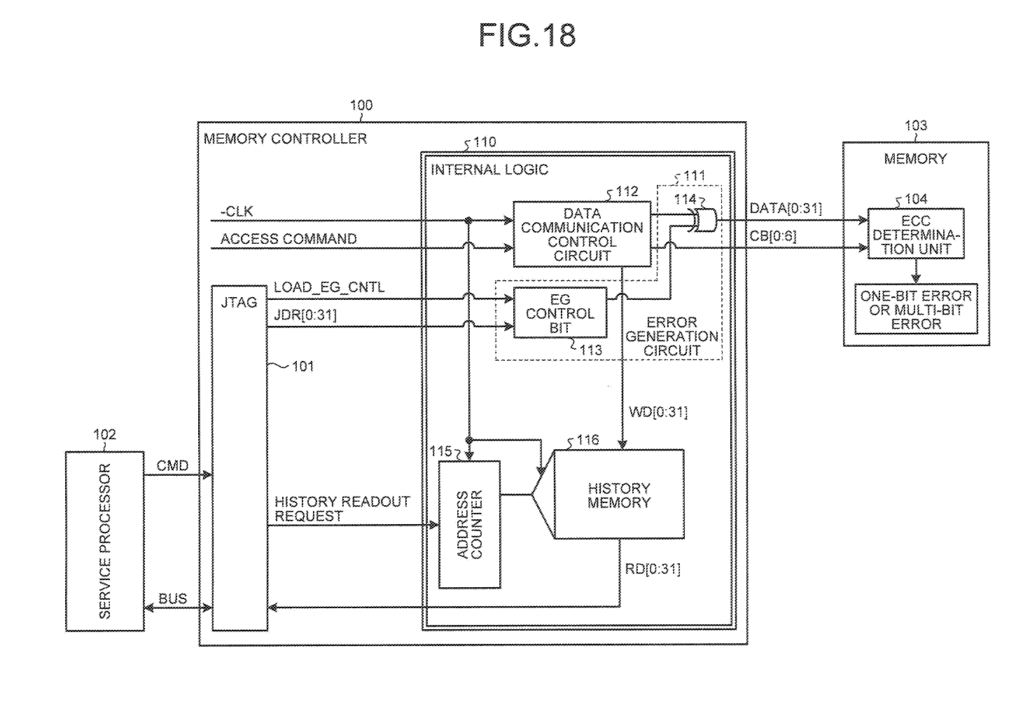

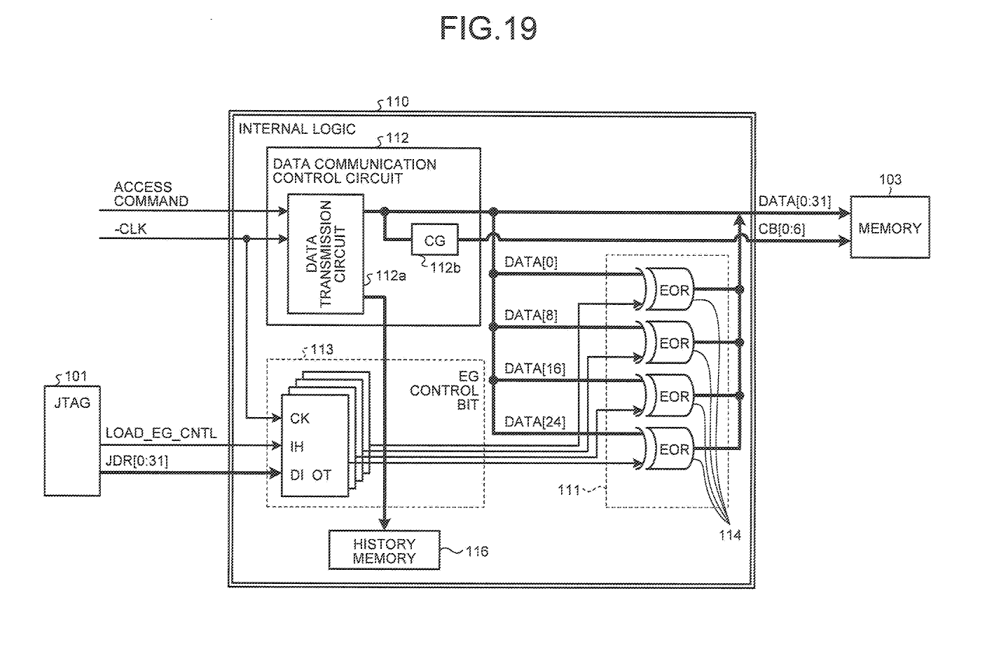

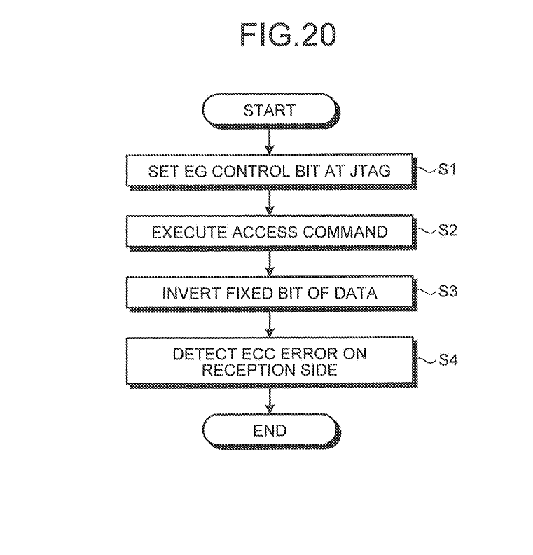

Then, the MAC is executes memory access indicative of reading out from the DIMM-L 4b (step S423). This allows the MAC 1a to detect an ECC error again from the read data (step S424). Thus, the service processor 3 determines whether the failure is permanent (step S425). If the failure is determined to be permanent (YES in step S425), the series of processes illustrated in FIG. 17 is executed.

On the other hand, if the service processor 3 has determined that the failure was not permanent (NO in step S475), the MAC 1a determines that the failure has occurred intermittently, and then repeats each process from step S401 again (step S426). Note that the MAC 1a executes the processing indicated by the steps S421 to S426 as Process 5. That is, the MAC 1a continually produces correctable pseudo errors in the DIMM-L 4b by executing Process 5, thereby determining that a permanent failure has occurred in the DIMM-L 4b and starting to execute a redundancy process to be discussed later.

Now, referring to FIG. 17, a description will be made to the flow of the process for the MAC 1a to make the data stored in the CS0 of the DIMM-L 4b redundant in the CS1. FIG. 17 is an explanatory second flowchart illustrating the flew of the process executed by the MAC according to the second embodiment. Note that the MAC 1a executes each process illustrated in FIG. 17 when being triggered by determining, in step S425 illustrated in FIG. 16, that a permanent failure has occurred in the DIMM-L 4b.

First, if it is determined that a permanent failure has occurred in the DIMM-L 4b, the service processor 3 issues a rewrite command for all the storage regions in the CS0 side of the DIMM-H 4a and the DIMM-L 4b (step S427). In such a case, the MAC 1a reads data on the CS0 side of the DIMM-H 4a and the DIMM-L 4b and executes a correction writing process on the CS1 side of the DIMM-H 4a and the DIMM-L 4b (step S428).

Note that to copy the data on the CS0 side to the CS1 side, the MAC 1a copies the data without executing bit inversion because the +CS_SEL is “High” and thus not coincident with the CS[0] stored in the EG control register 12a.

Next, the MAC in determines whether all the storage regions on the CS0 side of the DIMM-H 4a and the DIMM-L 4b have been copied to the CS1 side (step S429). If it is determined that all the storage regions have been copied (YES in step S429), the following processing will be executed. That is, using the JTAG command, the MAC 1a sets the ENBL[0] of the failure information. register 22 to “High,” and enables switching over to the CS1 or the redundant side, of the DIMM-H 4a and the DIMM-L 4b (step S430).

Next, the MAC in executes. memory access indicative of reading on the 4b (step S431), and reads data from the CS1 of the DIMM-L 4b (step S432). Since the MAC 1a herein copies data without performing bit inversion in step S428, no ECC error is detected from the data read in step S432 (step S433). Thus, the MAC 1a exits the redundancy process as appropriate.

Note that the MAC 1a executes the processing from the steps S427 to S429 as Process 6. That is, the MAC 1a executes Process 6 to thereby execute the redundancy process in which the data on the CS0 side is read and written onto the CS1 side without inserting an error into the read data. Furthermore, the MAC 1a executes the processing from the steps S430 to S433 as Process 7. That is, the MAC 1a executes Process 7, thereby determining whether the redundancy process has been appropriately performed to transfer data on the CS0 side to the CS1 side.

### Effects of the Second Embodiment

As described above, the DIMM-H 4a and the DIMM-L 4b have the CS0 or the storage region for storing the DQ[0:63] received from the MAC 1a and the CS1 or the redundant system for storing the copy of the data stored in the CS0 when the CS0 is failed. Then, the MAC 1a determines whether any correctable error is included in the data read from the CS0, and when it is determined that a correctable error is included, executes the following processing. That is, the MAC 1a corrects the read error and inserts a pseudo error into the error-corrected data, then writing back the data into which the pseudo error has been inserted. Then, the MAC 1a reads the data having been written back, and when a correctable error is detected again from the read data, executes the redundancy process to copy all the data stored in the CS0 side to the CS1 side.

Thus, the MAC 1a can evaluate the redundant function of the DIMM-H 4a and the DIMM-L 4b. That is, the MAC 1a inserts a pseudo error into data stored in the DIMM-H 4a and the DIMM-L 4b and reads again the data with the error inserted therein, thereby determining that a permanent failure has occurred. As a result, the MAC 1a can appropriately evaluate whether the redundant function can be properly exerted in the DIMM-H 4a and the DIMM-L 4b.

### [c] Third Embodiment

While embodiments of the present invention have been described above, another embodiment other than those described above may also be implemented in various different forms. In this context, a description will now be made to another embodiment as a third embodiment included in the present invention.

### (1) Concerning Each Signal

The aforementioned memory controller 1 inserts a pseudo error into the 32-bit DATA[0:31]. Furthermore, the aforementioned MAC 1a inserts a pseudo error by bit-inverting the 64-bit DQ[0:63] or the 8-bit CB[0:7]. However, the embodiment is not limited thereto. That is, a signal into which the memory controller 1 and the MAC 1a will insert a pseudo error may be any data having, a given number of bits.

Furthermore, the memory controller 1 and the MAC 1a mentioned above execute the test for verifying the RAS when the EN[0] is “High.” Furthermore, when the CN[0:1] is “10,” the memory controller 1 inserts continually multiple patterns of pseudo errors into the DATA[0:31]. However, the embodiment is not limited thereto, and the memory controller 1 can provide any setting for the action indicated by the CNT[0:1].

### (2) Concerning Memory Controller

In the aforementioned first embodiment, the memory controller 1 for evaluating the RAS of the memory 4 was described. On the other hand, in the aforementioned second embodiment, the MAC 1a for evaluating the RAS of the DIMM-H 4a and the DIMM-L 4b was described. However, the embodiment is not limited thereto, and any device for transmitting data to the object the RAS of which is to be evaluated could be provided with the same additional function as those of the memory controller 1 and the MAC 1a of the embodiments.

It is also possible to make use of the functions of the memory controller 1 and the MAC 1a of the aforementioned embodiments at the same time. That is, the MAC 1a may also continually insert multiple patterns of pseudo errors into the DQ_H[0:63].

### (3) Concerning Each Circuit

In the aforementioned first and second embodiments, the examples of circuits for making use of the functions of the memory controller 1 and the MAC 1a were described. However, the embodiment is not limited thereto, and a circuit having any configuration that is capable of making use of the same function may also be employed to achieve the same function.

In one aspect of an embodiment, the RAS is continually verified for multiple patterns of error.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data communication apparatus comprising:
a data generation unit that generates data to be transmitted to another apparatus;
a control register that outputs an enable signal indicative of whether to enable a test of the another apparatus and a test control signal to be used to control the test;
a memory which is used for a predetermined use during other than the test and in which pseudo failure data is written during the test, the pseudo failure, data being used to modify data generated by the data generation unit to data having a pseudo failure;
a memory address generation unit that generates a readout address of the memory during the test on the basis of the enable signal and the test control signal;
a failure, setting unit that, when the enable signal indicates that the test has been enabled, reads out pseudo failure data from the memory using a readout address generated by the memory address generation unit, and on the basis of the read pseudo failure data, modifies the data generated by the data generation. unit to data having the pseudo failure; and
a transmission unit that transmits the data having the pseudo failure modified by the failure setting unit to the another apparatus.

2. The data communication apparatus according to claim 1, wherein, during the test, the failure setting unit modifies the data generated by the data generation unit to data having a pseudo failure by an exclusive OR of the pseudo failure data read from the memory and the data generated by the data generation unit.

3. The data communication apparatus according to claim 1, wherein:
the memory stores multiple types of pseudo failure data; and
when the enable signal indicates that the test has been enabled, the memory address generation unit sequentially generates, on the basis of the test control signal, readout addresses of the memory at which the multiple types of pseudo failure data are stored.

4. The data communication apparatus according to claim 3, wherein:
the control register outputs the test. control signal indicative of setting of a fixed pattern of pseudo failure or setting of consecutive patterns of pseudo failure;
the memory address generation unit generates one memory address at which the pseudo failure data is written when the test control signal is indicative of setting of a fixed pattern of pseudo failure, and sequentially generates memory addresses at which the respective patterns of pseudo failure data are written when the test control signal is indicative of setting of consecutive patterns of pseudo failure; and
the failure setting unit modifies the data generated by the data generation unit to data having pseudo failure on the basis of pseudo failure data stored at the memory address generated by the memory address control unit when the test control signal is indicative of setting of the fixed pattern of pseudo failure, and sequentially modifies the data generated by the data generation unit to data having each pattern of pseudo failure using each pseudo failure stored in each of the memory addresses sequentially generated by the memory address control unit when the test control signal is indicative of setting of the consecutive patterns of pseudo failure.

5. The data communication apparatus according to claim 3, further comprising a storage unit that, during the test, receives the pseudo failure data entered by a user and stores the received pseudo failure data in the memory, and wherein
the memory stores the data generated by the data generation unit during other than the test, and stores the pseudo failure data stored by the storage unit during the test.

6. The data communication apparatus according to claim 3, wherein:
the another apparatus includes
a first storage region in which data transmitted by the data communication apparatus is stored, and
a second storage region in which a copy of the data stored in the first storage region is stored when the first storage region is failed;
the data communication apparatus includes
a readout unit that, when the transmission unit transmits data provided with the pseudo failure by the failure setting unit to the another apparatus, reads, from the first storage region, the data transmitted to the another apparatus,
a determination unit that determines whether a correctable error is included in the data read by the readout unit,
an error correction unit that, when the determination unit has determined that a correctable error is included in data corrects the error, and
a data transfer unit that, when an error is included again in the data the error of which was corrected by the error correction unit, transfers the data stored in the first storage region to the second storage region; and
the failure setting unit converts again the data the error of which is corrected by the error correction unit into data having the pseudo failure, and
the transmission unit transmits, to the first storage region, the data converted again by the failure setting unit into data having the pseudo failure data.

7. A method for controlling a data communication apparatus which transmits data to another apparatus, the method causing the data communication apparatus to execute:
firstly generating data to be transmitted to the another apparatus;
outputting an enable signal indicative of whether to enable a test of the another apparatus and a test control signal to be used to control the test;
secondly generating a readout address of a memory during the test on the basis of the enable signal and the test control signal;
reading pseudo failure data from the memory using the generated readout address when the enable signal indicates that the test has been enabled;
modifying the data generated in the firstly generating to data having a pseudo failure on the basis of the read pseudo failure data; and
transmitting the data having the pseudo failure to the another apparatus.
